(19) United States
(12) Patent Application Publication
(10) Pub. No.: US 2026/0206757 A1
(43) Pub. Date: Jul. 23, 2026

(54) METHODS OF CONTROLLING UNDESIRABLE PLANTS WITH PPO HERBICIDES AND COMBINATIONS IN HERBICIDE TOLERANT CROP PLANTS

(71) Applicant: BASF AGRO B.V., Arnhem (NL)

(72) Inventors: Matthias Pfenning, Limburgerhof (DE); Bianca Assis Barbosa Martins, Mannheim (DE)

(21) Appl. No.: 19/140,405

(22) PCT Filed: Dec. 21, 2023
(86) PCT No.: PCT/EP2023/087319

§ 371 Date: Jun. 18, 2025

(30) Foreign Application Priority Data
Dec. 22, 2022 (EP) 22216160.6

(51) Int. Cl. A01N 43/54; A01N 33/08; A01N 35/10; A01N 37/48; A01N 41/06; A01N 43/40; A01N 43/50; A01N 43/56; A01N 43/653; A01N 43/84; A01N 47/36; A01P 13/00

(52) U.S. Cl. CPC A01N 43/54; A01N 33/08; A01N 35/10; A01N 37/48; A01N 41/06; A01N 43/40; A01N 43/50; A01N 43/56; A01N 43/653; A01N 43/84; A01N 47/36; A01P 13/00

(57) ABSTRACT

The present invention relates to a method for weed control in PPO-inhibitor tolerant sunflower crop, comprising applying to the sunflower crop a composition, said composition comprising PPO-inhibitor (A) or an agriculturally acceptable salt or derivative thereof, wherein said PPO herbicide is saflufenacil and/or or flumioxazin. Said composition may further comprise at least one further herbicide (B) or an agriculturally acceptable salt or derivative thereof, said further herbicide is selected from the group consisting of Auxin mimics, inhibitors of Protoporphyrinogen Oxidase (PPO), Acetolactate Synthase (ALS), Acetyl CoA Carboxylase (ACCase), Very Long-Chain Fatty Acid (VLCFA) Synthesis, Microtubule Assembly and Photosynthesis at PSII, and combinations thereof.

### FIELD OF THE INVENTION

The present invention relates to a method for weed control in Protoporphyrinogen Oxidase (PPO)-inhibitor tolerant sunflower crop, comprising applying to the sunflower crop a composition, said composition comprising a Protoporphyrinogen Oxidase (PPO)-inhibitor (A) or an agriculturally acceptable salt or derivative thereof, wherein said PPO inhibitor (A) is Saflufenacil and/or Flumioxazin. Said composition may further comprise at least one further herbicide (B) or an agriculturally acceptable salt or derivative thereof, said further herbicide is selected from the group consisting of Auxin mimics, inhibitors of Protoporphyrinogen Oxidase (PPO), Acetolactate Synthase (ALS), Acetyl CoA Carboxylase (ACCase), Very Long-Chain Fatty Acid (VLCFA) Synthesis, Microtubule Assembly and Photosynthesis at PSII, and combinations thereof.

### BACKGROUND

In crop protection, it is desirable, in principle, to increase the specific activity of an active compound and the reliability of the effect. It is particularly desirable for the crop protection product to control the harmful plants effectively, but at the same time to be compatible with the useful plants in question. Also desirable is a broad spectrum of activity allowing the simultaneous control of harmful plants. Frequently, this cannot be achieved using a single herbicidally active compound.

Further, cases of herbicide-resistant weeds are becoming increasingly common. These biotypes survive herbicide application at doses that usually give effective control of the species. Resistant weed biotypes are a consequence of basic evolutionary processes. Individuals within a species that are best adapted to a particular practice are selected for and will increase in the population. Once a weed population is exposed to a herbicide to which one or more plants are naturally resistant, the herbicide kills susceptible individuals, but allows resistant individuals to survive and reproduce. With repeated herbicide use, resistant weeds that initially appear as isolated plants or patches in a field can quickly spread to dominate the population and the soil seed bank.

For example, herbicide resistance within weeds has become a major concern for farmers, resulting in dramatic weed control problems. Herbicides from the group of Acetolactate Synthase (ALS) and Acetyl CoA Carboxylase (ACCase) inhibitors are most affected by resistance evolution but also various other types of herbicides.

Imidazolinone herbicides share a common mechanism of herbicidal action that involves the inhibition of Acetolactate Synthase (ALS). For example, imazamox is an effective herbicide for weed control and is a member of the imidazolinone class of herbicides.

Sunflower (Helianthus annuus) is an important crop plant that is grown worldwide in temperate and subtropical climates. Sunflower is used primarily for the production of vegetable oil. Sunflower seeds are also used for animal feed (such as bird feed) and food manufacture.

The Clearfield system in sunflower is based on Imazamox and is widely used because the ALS-tolerant sunflowers can be sprayed over the top with the Clearfield herbicide (Imazamox), consistently controlling weed, while sunflower plants are tolerant to Imazamox. Due to the risk of ALS inhibitor-resistance evolution in sunflower weeds, it is of interest to develop sunflower plants which are tolerant to herbicide with a mode of action other than ALS inhibition.

Herbicides that inhibit Protoporphyrinogen Oxidase (hereinafter referred to as Protox or PPO; EC 1.3.3.4), a key enzyme in the biosynthesis of protoporphyrin IX, have been used for selective weed control since the 1960s. PPO catalyzes the last common step in chlorophyll and heme biosynthesis which is the oxidation of protoporphyrinogen IX to protoporphyrin IX.

PPO-inhibitors include many different structural classes of molecules (Duke et al. 1991. Weed Sci. 39:465; Nandihalli et al. 1992. Pesticide Biochem. Physiol. 43:193; Matringe et al. 1989. FEBS Lett. 245:35; Yanase and Andoh. 1989. Pesticide Biochem. Physiol. 35:70). These herbicidal compounds include (see HRAC Mode of Action Classification 2022 Map| Herbicide Resistance Action Committee (hracglobal.com)) Diphenyl ethers (e.g. Lactofen, Acifluorfen, Oxyfluorfen, Fomesafen, Bifenox), N-Phenyl-oxidiazolones, (e.g. Oxadiazon), N-Phenyl-imides (e.g. Saflufenacil, Flumioxazin, Trifludimoxazin), N-Phenyl-triazolinones (e.g. Sulfentrazone) and Pyraflufen-ethyl.

Herbicides targeting PPO (PPO-inhibitors) have a very rapid contact action, causing leaf burning, desiccation and growth inhibition (Li and Nicholl, Development of PPO inhibitor-resistant cultures and crops. PestManag Sci 61:277-285 (2005)). Although PPO targeting herbicides were developed more than 50 years ago, natural occurrence of weed resistance to PPO inhibitors has only been reported for a few plants, for example for Amaranthus palmeri (Salas et al Manag Sci. 2016 May; 72 (5): 864-9. doi: 10.1002/ps.4241. Epub 2016 Mar. 4. PMID: 26817647; PMCID: PMC5069602). Li and Nicholl (supra) describe that PPO herbicide-resistance mutations tend to reduce enzymatic function. This could explain why only a few plants developed resistant enzymes so far. Further, Li et al. (Plant Physiol 133:736-747 (2003)) describe that it was impossible to develop a field-resistant transgenic maize event without an increase in promoter activity driving the mutant PPO gene.

WO 2012/080975, WO 2013/189984, WO2015/022636 and WO 2016/203377 disclose plants in which the tolerance to PPO inhibitors had been increased by transforming said plants with nucleic acids encoding mutated PPO mutated enzymes. Amongst other crops, sunflower is mentioned as a target crop. In WO 2012/080975, WO2015/022636 and WO 2016/203377, transgenic plants have been produced expressing mutated PPO genes under control of the ubiquitin promoter which is a strong constitutive promoter. However, transgenic sunflowers were not produced.

The genome from sunflower has been sequenced. It is known that sunflower comprises two PPO genes, PPO1 and PPO2. For example, the sequence of the sunflower PPO2 gene is disclosed under NCBI-Protein ID XP_021982414.1. However, the PPO genes have not been analyzed so far, for example, in the context of PPO tolerance.

Since the modification of the genome of sunflower is difficult, sunflower plants which are tolerant to a broad spectrum of PPO inhibitors have not been reported. Therefore, PPO herbicides are currently only used for sunflower in pre-plant burndown and pre-emergence applications for controlling weeds, i.e. before the emergence of the sunflower plant.

The international patent application PCT/US2022/077037 (published as WO2023/049906A1) discloses a non-transgenic sunflower plant comprising a mutated protoporphyrinogen IX oxidase (PPO) gene encoding a mutated sunflower protoporphyrinogen IX oxidase, wherein the mutated sunflower protoporphyrinogen IX oxidase comprises a substitution of phenylalanine (F) to isoleucine (I) at a position corresponding to residue 383 in the protoporphyrinogen IX oxidase (F383I substitution). The plants were generated by mutagenesis.

US 2013/042366 A1 discloses crop plants comprising recombinant polynucleotides encoding a cytochrome P450 polypeptide (CYP450, CYP72A15, CYP81A or CYP73A), conferring tolerance to the herbicide saflufenacil. Examples for successfully transformed crop plants were corn and soybean. While sunflower was mentioned as “plant species of interest” for transformation, such recombinant sunflower plants were not generated.

Jursik M. et al. analysed the effects of different adjuvants on phytotoxicity of flumioxazin to sunflower in different growth stages (Romanian Agricultural Research, 17 Apr. 2013, pages 365-372). The authors found that flumioxazin may be applied to sunflower with at least two true leaves without high level of crop injury. However, for efficient weed control, adjuvants must be added, which leads to increased phytotoxicity in sunflower and inacceptable crop damage. The document does not disclose sunflower plants with tolerance to agronomically useful compositions comprising saflufenacil or flumioxazin.

CN 110 583 678 discloses a herbicide composition containing saflufenacil and bensulfuron-methyl in a certain weight ratio, suitable for saflufenacil-resistant or tolerant sunflower. However, there is no reference to a saflufenacil tolerant sunflower from the prior art and saflufenacil tolerant sunflower plants were not generated.

Methods are needed for controlling weed growth in the vicinity of such PPO tolerant sunflower plants or crop plants. These methods would allow for the use of spray over techniques (OTT (over the top)) when applying PPO herbicides to areas containing the non-transgenic sunflower plants. Also needed are methods which allow for using mixtures comprising at least one PPO herbicide and at least one further herbicide, e.g. an herbicide with a different mode of action.

### BRIEF SUMMARY OF THE PRESENT INVENTION

The present invention relates to a method for weed control in PPO-inhibitor tolerant sunflower crop, comprising applying pre-emergence or post-emergence of said sunflower crop to said sunflower crop and/or to the cultivation site of said sunflower crop a composition (I) comprising a PPO-inhibitor (A) or an agriculturally acceptable salt or derivative thereof, selected from the group consisting of Saflufenacil, Flumioxazin and combinations thereof. The cultivation site may be any site at which the sunflower is grown or will be grown.

In an embodiment, the PPO-inhibitor tolerant sunflower crop is a transgenic or non-transgenic PPO-inhibitor tolerant sunflower crop.

In an embodiment, the sunflower crop comprises a mutated protoporphyrinogen IX oxidase (PPO) gene encoding a mutated sunflower protoporphyrinogen IX oxidase, wherein the mutated sunflower protoporphyrinogen IX oxidase comprises a substitution of phenylalanine (F) to isoleucine (I) at a position corresponding to residue 383 relative to SEQ ID NO: 2 (F383l substitution).

In an embodiment, the mutated protoporphyrinogen IX oxidase comprises an amino acid sequence as shown in SEQ ID NO: 2, or a variant thereof being at least 98%, or at least 99% or at least 99.5% identical to SEQ ID NO: 2, with the proviso that the variant comprises a substitution of phenylalanine (F) to isoleucine (I) at a position corresponding to residue 383.

In an embodiment, the sunflower crop additionally comprises
a. a herbicide tolerance trait of (1) an AHASL (acetohydroxyacid synthase large subunit) having an A122(At) T substitution, or (2) an AHASL variant thereof that contains both the A122(At) T substitution and a second substitution that can be one or more of P197(At) Q, P197(At) S, P197(At)L T203(At) I, T203(At) X, A205(At) D, A205(At) V, W574(At) L, A653(At) N, A653(At) T, A653(At) F, or A653(At) V, wherein X may be selected as any natural amino acid;
b. two herbicide tolerance traits, the trait with the AHASL A122(At) T substitution and a second trait having an AHASL with an A205(At) V substitution, an AHASL with a P197(At) S substitution, an AHASL with a P197(At) L substitution or an AHASL with a W574(At) L substitution;
c. a herbicide tolerance trait having an AHASL with one A205(At) V substitution;
d. a herbicide tolerance trait having an AHASL with one P197(At) L substitution;
e. a herbicide tolerance trait having an AHASL with one P197(At) S substitution; or
f. a herbicide tolerance trait having an AHASL with one W574(At) L substitution.

In an embodiment, additionally a herbicide (B) or an agriculturally acceptable salt or derivative thereof is applied to the sunflower crop, wherein (B) is selected from the group consisting of Auxin mimics, inhibitors of Protoporphyrinogen Oxidase (PPO), Acetolactate Synthase (ALS), Acetyl CoA Carboxylase (ACCase), Very Long-Chain Fatty Acid (VLCFA) Synthesis, Microtubule Assembly and Photosynthesis at PSII, and combinations thereof.

In an embodiment, (B) is a further PPO-inhibitor selected from the group consisting of N-Phenyl-imides, Diphenyl ethers, N-Phenyl-triazolinones and Phenylpyrazoles. Preferably the further PPO-inhibitor is selected from the group consisting of Bifenox, Fomesafen, Acifluorfen, Oxyfluorfen, Carfentrazone, Pyraflufen-ethyl, Sulfentrazone, Trifludimoxazin and combinations thereof, more preferably, the further PPO-inhibitor is selected from the group consisting of Bifenox, Fomesafen, Carfentrazone, Pyraflufen-ethyl, Sulfentrazone, Trifludimoxazin and combinations thereof, most preferably, the further PPO-inhibitor is selected from the group consisting of Bifenox, Fomesafen, Pyraflufen-ethyl, Sulfentrazone, Trifludimoxazin and combinations thereof.

In a particular preferred embodiment, the further PPO inhibitor is Trifludimoxazin.

In an embodiment, (B) is an ALS inhibitor selected from the group consisting of imidazoliones, sulfonylureas and combinations thereof. Preferably, the ALS inhibitor is selected from the group consisting of Imazamox, Imazapyr, Imazethapyr, Tribenuron methyl, Thifensulfuron-methyl, Thiencarbazone-methyl, Sulfosulfuron, Tritosulfuron, Nicosulforon, Foramsulforon, lodosulfuron-methyl, Mesosulfuron-methyl, Metsulfuron-methyl and combinations thereof. More preferably, the ALS inhibitor is selected from the group consisting of Imazamox, Imazapyr, Imazethapyr, Tribenuron-methyl, Thifensulfuron-methyl, Thiencarbazone-methyl, Sulfosulfuron and combinations thereof, more preferably, the ALS inhibitor is selected from the group consisting of Imazamox, Imazapyr, Imazethapyr, Tribenuron-methyl, and combinations thereof.

In another embodiment, the ALS inhibitor is an Imidazolinone herbicide selected from Imazamox, Imazapyr, and Imazethapyr, preferably Imazamox. In another embodiment, the ALS inhibitor is Tribenuron-methyl.

In an embodiment, (B) is an ACCase inhibitor selected from the group consisting of Cyclohexanediones and Aryloxyphenoxy-propionates, more preferably selected from the group consisting of Cycloxydim, Clethodim, Tepraloxydim, Sethoxydim, Propaquizafop-ethyl, Clodinafop-ethyl, Fenoxaprop-ethyl, Quizalofop-ethyl and combinations thereof, more preferably selected from the group consisting of Cycloxydim, Clethodim, and combinations thereof, most preferably, the ACCase inhibitor is Cycloxydim.

In an embodiment, (B) is an inhibitor of Very Long-Chain Fatty Acid (VLCFA) Synthesis, preferably an alpha-Chloroacetamide, more preferably selected from the group consisting of Dimethenamid, Dimethenamid-P (DMTA-P), S-Metolachlor, Pethoxamid, Acetochlor, Metazachlor, and combinations thereof, more preferably selected from the group consisting of Dimethenamid-P, S-Metolachlor and combinations thereof.

In a preferred embodiment, (B) is DMTA-P.

In an embodiment, (B) is a Microtubule Assembly inhibitor, preferably selected from the group consisting of Pendimethalin, Trifluralin, and combinations thereof, more preferably (B) is Pendimethalin.

In an embodiment, (B) is an Auxin mimic, preferably a Pyridine-carboxylate, more preferably Halauxifen.

In an embodiment, (B) is an inhibitor of Photosynthesis at PSII, preferably a Triazine, e.g. Terbuthylazin.

In an embodiment, composition (I) comprises the additional herbicide (B).

In an embodiment, in addition to composition (I), a composition (II) comprising the herbicide (B) is applied to the sunflower crop and/or the cultivation site of the sunflower crop and, wherein composition (I) and composition (II) are applied separately or at the same time.

In an embodiment, the sunflower crop and/or the cultivation site of the sunflower crop is treated with composition (I) and composition (II) at the same time.

In an embodiment, the sunflower crop and/or the cultivation site of the sunflower crop is initially treated with composition (I) and subsequently with composition (II).

In an embodiment, the sunflower crop and/or the cultivation site of the sunflower crop is initially treated with composition (II) and subsequently with composition (I).

In an embodiment, composition (1) is applied by spraying, in particular foliar spraying.

In an embodiment, composition (II) is applied by spraying, in particular foliar spraying.

In an embodiment, composition (I) is applied in the form of microgranules.

In an embodiment, composition (II) is applied in the form of microgranules.

Herein, the application rates [g/ha] refer to the respective active ingredient.

In an embodiment, the application rate of the herbicide (A) is in the range of from 0.1 to 100 g/ha and in particular from 0.5 to 85 g/ha, such as 1, 6.25, 12.5, 18.75, 25, 40, 50, 60, 70, 71, 72 or 80 g/ha. As described above, the herbicide (A) is preferably applied pre-emergence or post-emergence to the sunflower crop and/or to the cultivation site of said sunflower crop. The cultivation site may be any site at which the sunflower is grown or will be grown, such as a greenhouse or a field. In case the cultivation site is a greenhouse, the application rate of the herbicide (A) is preferably in the range of from 0.1 to 100 g/ha, more preferably 0.1 to 10 g/ha, such as in the range of from 0.1 to 6.25 g/ha, such as 0.5, 1, 2 or 5 g/ha. Preferably, the cultivation site is a field. In this case, the application rate of the herbicide (A) is preferably in the range of from 0.1 to 100 g/ha, in particular from 1 to 90 g/ha, such as 1, 2, 5, 6.25, 12.5, 18.75, 25, 40, 50, 60, 70, 71, 72 or 80 g/ha.

In an embodiment, (A) is Flumioxazin or an agriculturally acceptable salt or derivative thereof and the application rate of the herbicide (A) is in the range of from 0.1 to 100 g/ha, preferably from 0.5 to 90 g/ha, and in particular from 40 to 80 g/ha, such as 40, 50, 60, 70, 71, 72 or 80 g/ha, in particular from 71 to 72 g/ha. In case the cultivation site is a greenhouse and (A) is Flumioxazin, the application rate of the herbicide (A) is preferably in the range of from 0.1 to 100 g/ha, more preferably 0.1 to 10 g/ha, such as in the range of from 0.1 to 6.25 g/ha, such as 0.1 to 5 g/ha, such as 0.5, 1, 2 or 5 g/ha. Preferably, the cultivation site is a field. In case the cultivation site is a field and (A) is Flumioxazin, the application rate of the herbicide (A) is preferably in the range of from 0.1 to 100 g/ha, in particular from 40 to 80 g/ha, such as 40, 50, 60, 70, 71, 72 or 80 g/ha, in particular from 71 to 72 g/ha.

In an embodiment, (A) is Saflufenacil or an agriculturally acceptable salt or derivative thereof and the application rate of the herbicide (A) is in the range of from 0.1 to 60 g/ha, preferably from 0.5 to 50 g/ha, such as 1, 2, 5, 6.25, 12.5, 18.75, 25 or 50 g/ha. In case the cultivation site is a greenhouse and (A) is Saflufenacil, the application rate of the herbicide (A) is preferably in the range of from 0.1 to 60 g/ha, more preferably 0.1 to 10 g/ha, such as in the range of from 0.1 to 6.25 g/ha, such as 0.1 to 5 g/ha, such as 0.5, 1, 2 or 5 g/ha. Preferably, the cultivation site is a field. In case the cultivation site is a field and (A) is Saflufenacil, the application rate of the herbicide (A) is preferably in the range of from 0.1 to 60 g/ha, more preferably 1 to 50 g/ha, such as 1, 2, 5, 6.25, 12.5, 18.75, 25 or 50 g/ha. In an embodiment, pre-emergence or post-emergence of the sunflower crop, the sunflower crop and/or the cultivation site of the sunflower crop is treated with a combination of two herbicides (A), Saflufenacil or an agriculturally acceptable salt or derivative thereof and Flumioxazin or an agriculturally acceptable salt or derivative thereof, and the application rate of Saflufenacil is in the range of from 0.1 to 60 g/ha, preferably from 0.5 to 50 g/ha, such as 1, 2, 5, 6.25, 12.5, 18.75, 25 or 50 g/ha, and the application rate of the Flumioxazin is in the range of from 0.1 to 100 g/ha, preferably from 0.5 to 90 g/ha, and in particular from 40 to 80 g/ha, such as 40, 50, 60, 70, 71, 72 or 80 g/ha g/ha.

In an embodiment, pre-emergence or post-emergence of the sunflower crop, the sunflower crop and/or the cultivation site of the sunflower crop is additionally treated with a herbicide (B) or an agriculturally acceptable salt or derivative thereof, wherein the application rate of the herbicide (B) is in the range of from 1 to 1500 g/ha and in particular from 1.5 to 1200 g/ha.

In an embodiment, pre-emergence or post-emergence of the sunflower crop, the sunflower crop and/or the cultivation site of the sunflower crop is additionally treated with a herbicide (B) or an agriculturally acceptable salt or derivative thereof, wherein (B) is a further PPO-inhibitor selected from the group consisting of Bifenox, Fomesafen, Pyraflufen-ethyl, Sulfentrazone, Trifludimoxazin and combinations thereof.

In an embodiment, (B) is Bifenox, and the application rate of the herbicide (B) is in the range of from 120 to 800 g/ha and in particular from 150 to 720 g/ha, such as 150, 360, 480, 600 or 720 g/ha.

In an embodiment, (B) is Fomesafen, and the application rate of the herbicide (B) is in the range of from 100 to 500 g/ha and in particular from 120 to 450 g/ha, such as 120, 187.5, 275, 350 or 450 g/ha.

In an embodiment, (B) is Pyraflufen-ethyl, and the application rate of the herbicide (B) is in the range of from 1 to 30 g/ha and in particular from 1.5 to 20 g/ha, such as 1.5, 5, 10. 15 or 20 g/ha.

In an embodiment, (B) is Sulfentrazone, and the application rate of the herbicide (B) is in the range of from 20 to 150 g/ha and in particular from 30 to 140 g/ha, such as 40, 75, 80, 100, 120 or 140 g/ha.

In an embodiment, (B) is Trifludimoxazin, and the application rate of the herbicide (B) is in the range of from 5 to 40 g/ha, and in particular from 12.5 to 37.5 g/ha, such as 15, 20, 25 or 30 g/ha.

In an embodiment, pre-emergence or post-emergence of the sunflower crop, the sunflower crop and/or the cultivation site of the sunflower crop is additionally treated with a herbicide (B) or an agriculturally acceptable salt or derivative thereof, wherein (B) is an ALS inhibitor selected from the group consisting of Imazamox, Imazapyr, Imazethapyr, Tribenuron-methyl and combinations thereof.

In an embodiment, (B) is Imazamox, and the application rate of the herbicide (B) is in the range of from 5 to 60 g/ha and in particular from 10 to 50 g/ha, such as 10, 25, 32, 40 or 50 g/ha.

In an embodiment, (B) is Imazapyr, and the application rate of the herbicide (B) is in the range of from 5 to 20 g/ha and in particular from 7.5 to 15 g/ha, such as 7.5, 10, 12.5 or 15 g/ha.

In an embodiment, (B) is Imazethapyr, and the application rate of the herbicide (B) is in the range of from 20 to 70 g/ha and in particular from 30 to 60 g/ha, such as 30, 40, 50 or 60 g/ha.

In an embodiment, (B) is Tribenuron-methyl, and the application rate of the herbicide (B) is in the range of from 2 to 40 g/ha and in particular from 5 to 30 g/ha, such as 5, 15, 18, 22.5 or 30 g/ha.

In an embodiment, pre-emergence or post-emergence of the sunflower crop, the sunflower crop and/or the cultivation site of the sunflower crop is additionally treated with a herbicide (B) or an agriculturally acceptable salt or derivative thereof, wherein (B) is selected from the group consisting of Cycloxydim, DMTA-P, Halauxifen, Pendimethalin and combinations thereof.

In an embodiment, (B) is Cycloxydim, and the application rate of the herbicide (B) is in the range of from 50 to 300 g/ha and in particular from 100 to 250 g/ha, such as 100, 150, 200 or 250 g/ha.

In an embodiment, (B) is Clethodim, and the application rate of the herbicide (B) is in the range of from 20 to 300 g/ha and in particular from 30 to 250 g/ha, such as 30, 100, 150, 200 or 250 g/ha.

In an embodiment, (B) is DMTA-P, and the application rate of the herbicide (B) is in the range of from 1 to 1500 g/ha and in particular from 50 to 1000 g/ha, such as 100, 350, 500, 650, 800 or 1000 g/ha.

In an embodiment, (B) is Halauxifen, and the application rate of the herbicide (B) is in the range of from 0.5 to 5 g/ha and in particular from 1 to 3 g/ha, such as 1, 1.5, 2, 2.5 or 3 g/ha.

In an embodiment, (B) is Pendimethalin, and the application rate of the herbicide (B) is in the range of from 200 to 1500 g/ha and in particular from 400 to 1400 g/ha, such as 600, 800, 1000, 1200 or 1400 g/ha.

The sunflower crop and/or the cultivation site of the sunflower crop is treated with the herbicide (A) and/or herbicide (B) pre- or post-emergence of the sunflower crop.

In case of a pre-emergence treatment, the herbicide (A) and/or herbicide (B) are applied before sowing of the sunflower crop, at the time of sowing, or after sowing up to the emergence of the sunflower crop. In an embodiment, the herbicide (A) and/or herbicide (B) is applied up to 14 days, such as up to 10 days, preferably up to 3 days after sowing of the PPO inhibitor tolerant sunflower crop.

In case of a post-emergence treatment, the herbicide (A) and/or herbicide (B) are applied after the emergence of the sunflower crop. In an embodiment, the herbicide (A) and/or herbicide (B) is applied at BBCH stages 11 to 18 of the PPO inhibitor tolerant sunflower crop.

In an embodiment, the weed to be controlled in PPO-inhibitor tolerant sunflower crop is at least one weed selected from the genera Convolvulus, Cirsium, Xanthium, Abuthilon, Polygonum, Sorghum, Portulaca, Ambroisa, Sonchus, Datura, Chenopodium, Amaranthus, Echinochloa, Setaria, Sinapis and Matricaria.

In another embodiment, the weed to be controlled in PPO-inhibitor tolerant sunflower crop is at least one weed selected from Convolvulus arvensis, Cirsium arvense, Xanthium spp., Abuthilon theophrasti, Polygonum spp., Sorghum halepense, Portulaca oleracea, Ambroisa artimisifolia, Sonchus oleraceus, Datura stramonium, Chenopodium album, Amaranthus spp., Echinochloa crus-galli. Setaria spp., Sinapis spp, and Matricaria chamomilla.

### DETAILED DESCRIPTION OF THE PRESENT INVENTION

### Definitions

In the studies described in the examples section, the inventors tested the effect of herbicidal compositions comprising two herbicides on the growth of undesirable plants (weeds) that typically affect sunflower plants. Specifically, the herbicidal effect of at least one PPO inhibitor (Saflufenacil or Flumioxazin) and a further herbicide were tested (e.g. Pendimethalin, Flumioxazin, Sulfentrazone) individually and in combination against a variety of undesirable plants, Amaranthus reteroflexus (Pigweed), Amaranthus palmeri (Palmer amaranth), Ambrosia trifida (Giant ragweed), Mercuralis annua (Annual mercury), Echinochloa crus-galli (Barnyard grass), Urochloa texana (Texas panicum), Eleusine indica (Goosegras), Setaria faberi (Giant foxtail) and Digitaria sanguinalis (Crabgrass). Surprisingly, combinations were identified which had a synergistic herbicidal effect on the growth of relevant sunflower weeds. Such combinations can be advantageously used in weed control in PPO-inhibitor tolerant sunflower crop.

As used herein “herbicide” refers to one or more agents, compounds and/or compositions having herbistatic and/or herbicidal activity.

As used herein, the terms “undesirable vegetation”, “undesirable species”, “undesirable plants”, “harmful plants”, “undesirable weeds”, “volunteer plants” or “harmful weeds” are used synonymously.

### Herbicides (A) and (B) and Herbicide Compositions Used in the Method of the Present Invention

As described above, composition (I) comprises a PPO-inhibitor (A) or an agriculturally acceptable salt or derivative thereof, selected from the group consisting of Saflufenacil, Flumioxazin and combinations thereof.

Additionally, preferably, a herbicide (B) or an agriculturally acceptable salt or derivative thereof is applied to the sunflower crop, wherein (B) is selected from the group consisting of Auxin mimics, inhibitors of Protoporphyrinogen Oxidase (PPO), Acetolactate Synthase (ALS), Acetyl CoA Carboxylase (ACCase), Very Long-Chain Fatty Acid (VLCFA) Synthesis, Microtubule Assembly and Photosynthesis at PSII, and combinations thereof.

The herbicide (B) may be comprised in composition (I), thus, may be applied to the sunflower plant together with herbicide (A). Alternatively, a composition (II) comprising herbicide (B) may be applied to the sunflower plant, wherein composition (I) and composition (II) may be applied to the sunflower plant separately or at the same time.

Thus, according to a preferred embodiment, composition (I) comprises the herbicide (B).

According to a further preferred embodiment, a composition (II) comprising the herbicide (B) is additionally applied to the sunflower crop, wherein composition (I) and composition (II) may be applied to the sunflower plant separately or at the same time. In one embodiment, the sunflower crop is initially treated with composition (I) and subsequently with composition (II). In another embodiment, the sunflower crop is initially treated with composition (II) and subsequently with composition (I).

Composition (I) and, if applied also compositing (II), can be applied in accordance with conventional methods, for example, by spraying, irrigation, dusting, or the like.

According to a preferred embodiment, composition (I) is applied to the plants by spraying, in particular foliar spraying or in the form of microgranules.

According to a further preferred embodiment, composition (II) is applied to the plants by spraying, in particular foliar spraying, or in the form of microgranules.

In an embodiment, composition (I) is applied by spraying.

Further, it is envisaged to apply composition (I) and optionally composition (II) post-emergence of the sunflower at any growth stage before row closure. Moreover, it is envisaged that the PPO-inhibitor is applied more than once.

Composition (I) may comprise besides herbicide (A), and optionally herbicide (B), other additives customary in crop protection. Additives include other herbicides, detergents, adjuvants, spreading agents, sticking agents, stabilizing agents, or the like.

Composition (I) can be a wet or dry preparation and can include, but is not limited to, flowable powders, emulsifiable concentrates, and liquid concentrates.

Composition (II) may comprise besides herbicide (B) other additives. Additives include other herbicides, detergents, adjuvants, spreading agents, sticking agents, stabilizing agents, or the like. Composition (II) can be a wet or dry preparation and can include, but is not limited to, flowable powders, emulsifiable concentrates, and liquid concentrates.

Generally, if the herbicides which can be employed in the context of the present invention, are capable of forming geometrical isomers, for example E/Z isomers, it is possible to use both, the pure isomers and mixtures thereof, in the compositions useful for the present invention. If the herbicides as described herein have one or more centers of chirality and, as a consequence, are present as enantiomers or diastereomers, it is possible to use both, the pure enantiomers and diastereomers and their mixtures, in the compositions according to the invention.

If the herbicides as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C1-C4-alkyl, hydroxy-C1-C4-alkyl, C1-C4-alkoxy-C1-C4-alkyl, hydroxy-C1-C4-alkoxy-C1-C4-alkyl, phenyl or benzyl, preferably ammonium, methylammonium, isopropylammonium, dimethylammonium, diisopropylammonium, trimethylammonium, heptylammonium, dodecylammonium, tetradecylammonium, tetramethylammonium, tetraethylammonium, tetrabutylammonium, 2-hydroxyethylammonium (olamine salt), 2-(2-hydroxyeth-1-oxy) eth-1-ylammonium (diglycolamine salt), di(2-hydroxyeth-1-yl) ammonium (diolamine salt), tris(2-hydroxyethyl) ammonium (trolamine salt), tris(2-hydroxypropyl) ammonium, benzyltrimethylammonium, benzyltriethylammonium, N, N, N-trimethylethanolammonium (choline salt), furthermore phosphonium ions, sulfonium ions, preferably tri (C1-C4-alkyl) sulfonium, such as trimethylsulfonium, and sulfoxonium ions, preferably tri (C1-C4-alkyl) sulfoxonium, and finally the salts of polybasic amines such as N, N-bis-(3-aminopropyl)methylamine and diethylenetriamine. Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C1-C4-alkanoic acids, preferably formate, acetate, propionate and butyrate.

The herbicides as described herein having a carboxyl group can be employed in the form of the acid, in the form of an agriculturally suitable salt as mentioned above or else in the form of an agriculturally acceptable derivative, for example as amides, such as mono- and di-C1-C6-alkylamides or arylamides, as esters, for example as allyl esters, propargyl esters, C1-C10-alkyl esters, alkoxyalkyl esters, tefuryl ((tetrahydrofuran-2-yl)methyl) esters and also as thioesters, for example as C1-C10-alkylthio esters. Preferred mono- and di-C1-C6-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl(2-ethylhexyl) esters. Preferred C1-C4-alkoxy-C1-C4-alkyl esters are the straight-chain or branched C1-C4-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C1-C10-alkylthio ester is the ethylthioester.

### Herbicide A:

According to a preferred embodiment, composition (I) comprises a PPO-inhibitor (A) or an agriculturally acceptable salt or derivative thereof, wherein (A) is saflufenacil.

Saflufenacil is the common name of 2-chloro-5-[3,6-dihydro-3-methyl-2,6-dioxo-4-(trifluoromethyl)-1-(2H) pyrimidinyl]-4-fluoro-N-[[methyl (1-methylethyl)amino]-sulfonyl]benzamide. Saflufenacil is a herbicidal active substance which has been disclosed in WO 01/083459. Further processes for its preparation are described in WO 03/097589, WO 05/054208, and WO 06/125746. A crystalline and essentially solvent-free form of saflufenacil, also referred to as the crystalline anhydrate form, is disclosed in WO 08/043835.

The application rate of Saflufenacil is preferably in the range of from 0.1 to 60 g/ha and in particular from 0.5 to 50 g/ha, such as 0.5, 1, 2, 5, 6.25, 12.5, 18.75, 25 or 50 g/ha.

It is to be understood that the amount g/ha as used in the context of the present invention refers to the amount of the active ingredient (ai) applied, thus in this case to the total amount of saflufenacil applied.

According to a further preferred embodiment, composition (I) comprises a PPO-inhibitor (A) or an agriculturally acceptable salt or derivative thereof, wherein (A) is Flumioxazin. The herbicide Flumioxazin, chemical name 2-[7-fluoro-3,4-dihydro-3-oxo-4-(2-propyn-1-yl)-2H-1,4-benzoxazin-6-yl]-4,5,6,7-tetrahydro-1H-isoindole-1,3 (2H)-dione, is the active ingredient in the commercially available herbicide Valor® (available from Valent USA Corporation). The application rate of Flumioxazin is preferably in the range of from 0.1 to 100 g/ha and in particular from 0.5 to 90 g/ha, such as 0.5, 1, 40, 50, 60, 70, 71, 72 or 80 g/ha g/ha

According to a further preferred embodiment, composition (I) comprises a PPO-inhibitor (A) or an agriculturally acceptable salt or derivative thereof, wherein (A) is a combination of Saflufenacil and Flumioxazin. In this case, the application rate of Flumioxazin is preferably in the range of from 0.1 to 100 g/ha and in particular from 0.5 to 90 g/ha, such as 0.5, 1, 0, 50, 60, 70, 71, 72 or 80, and the application rate of Saflufenacil is preferably in the range of from 0.1 to 60 g/ha and in particular from 0.5 to 50 g/ha, such as 0.5, 1, 2, 5, 6.25, 12.5, 18.75, 25 or 50 g/ha.

In a preferred embodiment, wherein (A) is a combination of Saflufenacil and Flumioxazin. the weight ratio of Saflufenacil to Flumioxazin is the range of from 1:10 to 1:0.5, preferably from 1:7 to 1:0.7.

Surprisingly, it has been found that the combination of Saflufenacil and Flumioxazin is capable of providing a synergistic (over-additive) herbicidal effect.

### Herbicide (B)

As described above, preferably, in addition to herbicide (A), at least one herbicide (B) is applied to the sunflower crop and/or the cultivation site of the sunflower crop, wherein herbicide (B) is preferably selected from the group consisting of Auxin mimics, inhibitors of Protoporphyrinogen Oxidase (PPO), Acetolactate Synthase (ALS), Acetyl CoA Carboxylase (ACCase), Very Long-Chain Fatty Acid (VLCFA) Synthesis, Microtubule Assembly and Photosynthesis at PSII, and combinations thereof.

Surprisingly, it has been found that the combination of herbicide (A) and herbicide (B) is capable of providing a synergistic (over-additive) herbicidal effect.

Thus, in the methods of this invention, the herbicide (A) and herbicide (B) are each present or applied in an amount sufficient to provide a synergistic herbicidal effect. Such amounts are disclosed elsewhere herein.

The term “synergistic herbicidal effect” refers to the in vivo interaction of two or more biologically active compounds. so that their combined effect when administered together is greater than the sum of the effects observed when each is administered individually.

In some embodiments of this invention, Colby's equation is applied to determine whether the combination of herbicide (A) and herbicide (B) shows a synergistic effect (see S. R. Colby, “Calculating synergistic and antagonistic responses of herbicide combinations”, Weeds 1967, 15, pp. 20-22

$$E = X + Y - ( XY / 100 )$$

where
X=effect in percent using herbicide (A) at an application rate a;
Y=effect in percent using herbicide (B) at application rate b;
E=expected effect (in %) of herbicide (A)+herbicide (B) at application rates a+b.

In Colby's equation, the value E corresponds to the effect (plant damage or injury) which is to be expected if the activity of the individual compounds is additive. If the observed effect is higher than the value E calculated according to the Colby equation, a synergistic effect is present.

In one embodiment of the present invention, the compositions, uses and methods disclosed herein are synergistic as determined by the Colby equation. Specifically, the synergistic herbicidal effect is determined according to the Colby equation.

Moreover, the methods of the present invention provide excellent pre and post-emergence control of weeds. In one embodiment, the compositions and methods are useful for controlling undesirable vegetation before their emergence (pre-emergence). In another embodiment, the compositions and methods are also useful for controlling undesirable vegetation after their emergence (post-emergence).

The compositions, uses and methods of the present invention also show good crop compatibility, i.e. the combined application of (a) herbicide (A) and (b) herbicide (B) in crops does not result in increased damage of the crop plants when compared to the individual application of herbicide (A) or herbicide (B).

Furthermore, the methods of the present invention provide effective control of weeds that are known to affect the growth of sunflower plants. Such weeds are disclosed elsewhere herein. Preferably, pre-emergence or post-emergence of the sunflower crop, the sunflower crop and/or the cultivation site of the sunflower crop is additionally treated with the herbicide (B) or an agriculturally acceptable salt or derivative thereof with an application rate of the herbicide (B) typically in the range of from 1 to 1500 g/ha and in particular from 1.5 to 1200 g/ha. The particularly preferred application rate of the herbicide (B) thereby depends on the respective herbicide chosen.

According to a preferred embodiment, (B) is a further PPO-inhibitor. In said case (B) is preferably selected from the group consisting of N-Phenyl-imides, Diphenyl ethers, N-Phenyl-triazolinones and Phenylpyrazoles, more preferably the further PPO-inhibitor is selected from the group consisting of Bifenox, Fomesafen, Aciflurofen, Oxyflurofen, Carfentrazone, Pyraflufen-ethyl, Sulfentrazone, Trifludimoxazin and combinations thereof. It is to be understood that this includes agriculturally acceptable salt or derivative thereof.

More preferably, the further PPO-inhibitor is selected from the group consisting of Bifenox, Fomesafen, Carfentrazone, Pyraflufen-ethyl, Sulfentrazone, Trifludimoxazin and combinations thereof, most preferably, the further PPO-inhibitor is selected from the group consisting of Bifenox, Fomesafen, Pyraflufen-ethyl and combinations thereof. Preferably, in said case, the application rate of the herbicide (B) is preferably in the range of from 1 to 750 g/ha.

In case (B) is Bifenox (Methyl 5-(2,4-dichlorophenoxy)-2-nitrobenzoate), the application rate of the herbicide (B) is preferably in the range of from 120 to 800 g/ha, more preferably in the range of from 120 to 750 g/ha and in particular from 150 to 720 g/ha, such as 150, 360, 480, 600 or 720 g/ha.

In a preferred embodiment, wherein (A) is Saflufenacil and (B) is Bifenox, the weight ratio of Saflufenacil to Bifenox is the range of from 1:70 to 1:7, preferably from 1:60 to 1:12. In another preferred embodiment, wherein (A) is Flumioxazin and (B) is Bifenox, the weight ratio of Flumioxazin to Bifenox is the range of from 1:20 to 1:2, preferably from 1:18 to 1:4.

In case (B) is Fomesafen (5-[2-Chloro-4-(trifluoromethyl) phenoxy]-N-(methanesulfonyl)-2-nitrobenzamide), the application rate of the herbicide (B) is preferably in the range of from 100 to 500 g/ha, more preferably in the range of from 120 to 450 g/ha and in particular from 180 to 450 g/ha, such as 120, 187.5, 275, 350 or 450 g/ha.

In a preferred embodiment, wherein (A) is Saflufenacil and (B) is Fomesafen, the weight ratio of Saflufenacil to Fomesafen is the range of from 1:50 to 1:3, preferably from 1:40 to 1:5. In another preferred embodiment, wherein (A) is Flumioxazin and (B) is Fomesafen, the weight ratio of Flumioxazin to Fomesafen is the range of from 1:20 to 1:1, preferably from 1:12 to 1:2.

In case, (B) is Pyraflufen-ethyl (ethyl 2-[2-chloro-5-[4-chloro-5-(difluoromethoxy)-1-methylpyrazol-3-yl]-4-fluorophenoxy]acetate), the application rate of the herbicide (B) is preferably in the range of from 1 to 30 g/ha, more preferably in the range of from 1 to 25 g/ha and in particular from 5 to 20 g/ha, such as 1.5, 5, 10. 15 or 20 g/ha.

In a preferred embodiment, wherein (A) is Saflufenacil and (B) is Pyraflufen-ethyl, the weight ratio of Saflufenacil to Pyraflufen-ethyl is the range of from 1:3 to 1:0.05, preferably from 1:2 to 1:0.1.

In another preferred embodiment, wherein (A) is Flumioxazin and (B) is Pyraflufen-ethyl, the weight ratio of Flumioxazin to Pyraflufen-ethyl is the range of from 1:1 to 1:0.02, preferably from 1:0.8 to 1:0.05.

In case, (B) is Sulfentrazone (N-{2,4-Dichloro-5-[4-(difluoromethyl)-3-methyl-5-oxo-4,5-dihydro-1H-1,2,4-triazol-1-yl]phenyl}methanesulfonamide), the application rate of the herbicide (B) is preferably in the range of from 20 to 150 g/ha, more preferably in the range of from 20 to 150 g/ha and in particular from 30 to 140 g/ha, such as 40, 75, 80, 100, 120 or 140 g/ha.

In a preferred embodiment, wherein (A) is Saflufenacil and (B) is Sulfentrazone, the weight ratio of Saflufenacil to Sulfentrazone is the range of from 1:20 to 1:1, preferably from 1:15 to 1:2

In another preferred embodiment, wherein (A) is Flumioxazin and (B) is Sulfentrazone, the weight ratio of Flumioxazin to Sulfentrazone is the range of from 1:5 to 1:0.5, preferably from 1:4 to 1:0.8.

In case, (B) is Trifludimoxazin (1,5-dimethyl-6-sulfanylidene-3-(2,2,7-trifluoro-3-oxo-4-prop-2-ynyl-1,4-benzoxazin-6-yl)-1,3,5-triazinane-2,4-dione), the application rate of the herbicide (B) is preferably in the range of from 5 to 40 g/ha, preferably in the range from 10 to 38 g/ha and more preferably in the range from 12.5 to 37.5 g/ha.

In a preferred embodiment, wherein (A) is Saflufenacil and (B) is Trifludimoxazin, the weight ratio of Saflufenacil to Trifludimoxazin is the range of from 1:10 to 10:1, preferably from 1:5 to 5:1, more preferably 1:2 to 2:1.

In another preferred embodiment, wherein (A) is Flumioxazin and (B) is Trifludimoxazin, the weight ratio of Flumioxazin to Trifludimoxazin is the range of from 1:10 to 10:1, preferably from 1:5 to 5:1, more preferably 1:2 to 2:1.

According to a further preferred embodiment, (B) is an ALS inhibitor. Acetolactate synthase (ALS) inhibitors are also known as acetohydroxyacid synthase (AHAS) inhibitors. ALS inhibitors are compounds which have a Mode of Action which includes the inhibition of branched chain amino acid biosynthesis steps in plants and which belong to group B of the HRAC Classification (see HRAC, Classification of hormones according to Mode of Action, http://www.plantprotection.org/HRAC/MOA.html).

The term “ALS inhibitor” is also meant herein to include the respective salts, isomers and esters of the above compounds, as already discussed above. Suitable salts are, in particular, alkali metal or alkaline earth metal salts or ammonium salts or organic ammonium salts, such as sodium, potassium, ammonium, isopropylammonium salts and the like. Suitable isomers are, for example, stereoisomers such as enantiomers. Suitable esters are, for example, C1-C8 (branched or unbranched) alkyl esters, such as methyl, ethyl and isopropyl esters.

In case (B) is an ALS inhibitor, the ALS inhibitor is preferably selected from the group consisting of imidazolinones, sulfonylureas and combinations thereof, more preferably, the ALS inhibitor is selected from the group consisting of Imazamox, Imazapyr, Imazethapyr, Tribenuron methyl, Thifensulfuron-methyl, Thiencarbazone-methyl, Sulfosulfuron, Tritosulfuron, Nicosulforon, Foramsulforon, lododulfuron-methyl, Mesosulforon-methyl, Metsulfuron-methyl and combinations thereof, more preferably, the ALS inhibitor is selected from the group consisting of Imazamox, Imazapyr, Imazethapyr, Tribenuron-methyl, Thifensulfuron-methyl, Thiencarbazone-methyl, Sulfosulfuron and combinations thereof, more preferably, the ALS inhibitor is selected from the group consisting of Imazamox, Imazapyr, Imazethapyr, Tribenuron-methyl, and combinations thereof. Preferably, in said case, the application rate of the herbicide (B) is preferably in the range of from 2 to 100 g/ha, more preferably in the range of from 5 to 70 g/ha.

In case, (B) is Imazamox (5-(methoxymethyl)-2-(4-methyl-5-oxo-4-propan-2-yl-1H-imidazol-2-yl)pyridine-3-carboxylic acid), the application rate of the herbicide (B) is preferably in the range of from 5 to 60 g/ha, more preferably in the range of from 10 to 60 g/ha and in particular from 10 to 50 g/ha, such as 10, 15, 25, 32, 40 or 50 g/ha.

In a preferred embodiment, wherein (A) is Saflufenacil and (B) is Imazamox, the weight ratio of Saflufenacil to Imazamox is the range of from 1:10 to 1:0.2, preferably from 1:5 to 1:1. In another preferred embodiment, wherein (A) is Flumioxazin and (B) is Imazamox, the weight ratio of Flumioxazin to Imazamox is the range of from 1:2 to 1:0.1, preferably from 1:1.25 to 1:0.3.

In case, (B) is Imazapyr ((RS)-2-(4-Methyl-5-oxo-4-propan-2-yl-1H-imidazol-2-yl)pyridine-3-carboxylic acid), the application rate of the herbicide (B) is preferably in the range of from 2 to 30 g/ha, more preferably in the range of from 5 to 20 g/ha and in particular from 7.5 to 15 g/ha, such as 7.5, 10, 12.5 or 15 g/ha.

In a preferred embodiment, wherein (A) is Saflufenacil and (B) is Imazapyr, the weight ratio of Saflufenacil to Imazapyr is the range of from 1:3 to 1:0.1, preferably from 1:1.5 to 1:0.2.

In another preferred embodiment, wherein (A) is Flumioxazin and (B) is Imazapyr, the weight ratio of Flumioxazin to Imazapyr is the range of from 10:5 to 10:0.5, preferably from 10:4 to 10:0.8.

In case, (B) is Imazethapyr (5-ethyl-2-(4-methyl-5-oxo-4-propan-2-yl-1H-imidazol-2-yl)pyridine-3-carboxylic acid), the application rate of the herbicide (B) is preferably in the range of from 10 to 100 g/ha, more preferably in the range of from 20 to 70 g/ha and in particular from 30 to 60 g/ha, such as 30, 40, 50 or 60 g/ha.

In a preferred embodiment, wherein (A) is Saflufenacil and (B) is Imazethapyr, the weight ratio of Saflufenacil to Imazethapyr is the range of from 1:10 to 1:0.5, preferably from 1:5 to 1:1.

In another preferred embodiment, wherein (A) is Flumioxazin and (B) is Imazethapyr, the weight ratio of Flumioxazin to Imazethapyr is the range of from 1:3 to 1:0.1, preferably from 1:2 to 1:0.2.

In case, (B) is Tribenuron-methyl (Methyl 2-[[(4-methoxy-6-methyl-1,3,5-triazin-2-yl)-methylcarbamoyl]sulfamoyl]benzoate), the application rate of the herbicide (B) is preferably in the range of from 2 to 40 g/ha and in particular from 5 to 30 g/ha, such as 5, 15, 18, 22.5 or 30 g/ha.

In a preferred embodiment, wherein (A) is Saflufenacil and (B) is Tribenuron-methyl, the weight ratio of Saflufenacil to Tribenuron-methyl is the range of from 1:5 to 1:0.3, preferably from 1:3 to 1:0.5.

In another preferred embodiment, wherein (A) is Flumioxazin and (B) is Tribenuron-methyl, the weight ratio of Flumioxazin to Tribenuron-methyl is the range of from 1:1 to 1:0.05, preferably from 1:0.75 to 1:0.1.

According to a further preferred embodiment, (B) is an ACCase inhibitor (HRAC group A) Acetyl coA carboxylase (ACCase, EC 6.4.1.2), catalyzing carboxylation of acetyl-CoA to malonyl-CoA in a multistep reaction, is involved in the first committed step in fatty acid biosynthesis (Tang et al., Front. Agron., 23 Oct. 2020, p. 1-10).

In said case, (B) is preferably selected from the group consisting of DIMs, FOPs and combinations thereof, more preferably selected from the group consisting of Cycloxydim, Clethodim, Tepraloxydim, Sethoxydim, Propaquizafop-ethyl, Clodinafop-ethyl, Fenoxaprop-ethyl, Quizalofop-ethyl and combinations thereof, more preferably selected from the group consisting of Cycloxydim, Clethodim, and combinations thereof, most preferably, the ACCase inhibitor is Cycloxydim. Preferably, in said case, the application rate of the herbicide (B) is in the range of from 20 to 400 g/ha, more preferably in the range of from 50 to 300 g/ha.

In case, (B) is Cycloxydim, the application rate of the herbicide (B) is preferably in the range of from 20 to 400 g/ha, more preferably in the range of from 50 to 300 g/ha and in particular from 100 to 250 g/ha, such as 100, 150, 200 or 250 g/ha.

In a preferred embodiment, wherein (A) is Saflufenacil and (B) is Cycloxydim, the weight ratio of Saflufenacil to Cycloxydim is the range of from 1:30 to 1:2, preferably from 1:25 to 1:3. In another preferred embodiment, wherein (A) is Flumioxazin and (B) is Cycloxydim, the weight ratio of Flumioxazin to Cycloxydim is the range of from 1:0.5 to 1:10, preferably from 1:1 to 1:7.

In case (B) is Clethodim, and the application rate of the herbicide (B) is in the range of from 20 to 300 g/ha and in particular from 30 to 250 g/ha, such as 30, 100, 150, 200 or 250 g/ha. In a preferred embodiment, wherein (A) is Saflufenacil and (B) is Clethodim, the weight ratio of Saflufenacil to Clethodim is the range of from 1:70 to 1:2, preferably from 1:60 to 1:7. In another preferred embodiment, wherein (A) is Flumioxazin and (B) is Clethodim, the weight ratio of Flumioxazin to Clethodim is the range of from 1:0.5 to 1:10, preferably from 1:1 to 1:7.

According to a further preferred embodiment, (B) is an inhibitor VLCFA (very long chain fatty acid) synthesis. Inhibitors of VLCFA synthesis are compounds which have a mode of action comprising the inhibition of the VLCFA synthesis and/or the inhibition of cell division in plants and which belong to the group K3 of the HRAC classification system (see HRAC, Classification of Herbicides According to Mode of Action, http://www.plantprotection.org/hrac/MOA.html). VLCFA inhibitors include, e.g., Dimethenamid-P, Metazachlor, Metolachlor, S-Metolachlor, Pethoxamid, Pretilachlor, Propachlor, Propisochlor, oxyacetamide herbicides, such as Flufenacet and Mefenacet, acetamide herbicides, such as Diphenamid, Napropamide and Naproanilide, tetrazolinone herbicides, such as Fentrazamide as well as VLCFA-herbicides not belonging to a common group, such as Anilofos, Cafenstrole and Piperophos.

Preferably, the inhibitor of VLCFA synthesis is selected from the group consisting of an alpha-Chloroacetamine, more preferably selected from the group consisting of Dimethenamid-P (DMTA-P), S-Metolachlor, Pethoxamid, Acetochlor, Metazachlor, and combinations thereof, more preferably selected from the group consisting of Dimethenamid-P, S-Metolachlor and combinations thereof.

In case, (B) is DMTA-P, the application rate of the herbicide (B) is preferably in the range of from 1 to 1500 g/ha, preferably in the range of from 50 to 1000 g/ha and in particular from 100 to 1000 g/ha, such as 100, 200, 350, 500, 650, 800 or 1000 g/ha.

In a preferred embodiment, wherein (A) is Saflufenacil and (B) is DMTA-P, the weight ratio of Saflufenacil to DMTA-P is the range of from 1:100 to 1:5, preferably from 1:80 to 1:10. In another preferred embodiment, wherein (A) is Flumioxazin and (B) is DMTA-P, the weight ratio of Flumioxazin to DMTA-P is the range of from 1:1 to 1:30, preferably from 1:4 to 1:20.

According to a further preferred embodiment, (B) is an inhibitor of Microtuble Assembly (“MTA inhibitor”). MTA inhibitors are compounds which have a mode of action comprising the inhibition of the microtubule assembly in plants and which belong to the group K1 of the HRAC classification system (see HRAC, Classification of Herbicides According to Mode of Action, http://www.plantprotection.org/hrac/MOA.html). MTA inhibitors include e.g. dinitroaniline herbicides, such as Benfluralin, Butralin, Dinitramine, Ethalfluralin, Oryzalin, Pendimethalin, and Trifluralin, phosphoroamidate herbicides, such as Amiprophos-methyl and Butamiphos, pyridine herbicides, such as Dithiopyr and Thiazopyr, benzamide herbicides, such as Propyzamide and Tebutam, and benzoic acid herbicides, such as Chlorthal.

Preferably, the MTA inhibitor is selected from the group consisting of Pendimethalin, Trifluralin, and combinations thereof, more preferably (B) is Pendimethalin.

In case, (B) is Pendimethalin, the application rate of the herbicide (B) is in the range of preferably of from 200 to 1500 g/ha, more preferably of from 400 to 1400 g/ha and in particular from 600 to 1200 g/ha, such as 600, 800, 1000 or 1200 g/ha.

In a preferred embodiment, wherein (A) is Saflufenacil and (B) is Pendimethalin, the weight ratio of Saflufenacil to Pendimethalin is the range of from 1:150 to 1:10, preferably from 1:100 to 1:20.

In another preferred embodiment, wherein (A) is Flumioxazin and (B) is Pendimethalin, the weight ratio of Flumioxazin to Pendimethalin is the range of from 1:1 to 1:40, preferably from 1:5 to 1:30.

According to a further preferred embodiment, (B) is an Auxin mimic. Auxin mimics belong to the group 0 of the HRAC classification system and mimic the effect of auxin or indole-3-acetic acid (IAA), a plant growth hormone in higher plants. They are often called growth regulators because they upset the natural hormone balance in the plant. They are supposed to bind to transport inhibitor response 1 (TIR1) and auxin F-box (AFB) auxin receptors.

Exemplary synthetic Auxin mimics include, but are not limited to, 2,4-D, 2,4-DB, Aminocyclopyrachlor, Aminopyralid, Clomeprop-P, Clopyralid, Dicamba, Diclorprop-P, Fluoroxypyr methylheptyl ester (MHE), MCPA, Mecoprop-P, Picloram, Quinclorac, Triclopyr, Halauxifen and Halauxifen-methyl.

In case (B) is an Auxin mimic, (B) is preferably a Pyridine-carboxylate, more preferably Halauxifen.

In case, (B) is Halauxifen, the application rate of the herbicide (B) is preferably in the range of preferably of from 0.5 to 10 g/ha, more preferably of from 0.5 to 5 g/ha and in particular from 1 to 3 g/ha, such as 1, 1.5, 2, 2.5 or 3 g/ha.

In a preferred embodiment, wherein (A) is Saflufenacil and (B) is Halauxifen, the weight ratio of Saflufenacil to Halauxifen is the range of from 10:4 to 10:0.4 preferably from 10:3 to 10:0.5.

In another preferred embodiment, wherein (A) is Flumioxazin and (B) is Halauxifen, the weight ratio of Flumioxazin to Halauxifen is the range of from 100:1 to 100:10, preferably from 100:2 to 100:8.

According to a further preferred embodiment, (B) is an inhibitor of Photosynthesis at PSII. These inhibitors include triazines, such as Atrazine; triazinones, such as Terbuthylazine, Metribuzin; uracils, such as Bromacil; nitriles, such as Bromoxynil; benzothiadiazoles, such as Bentazon; and ureas, such as Diuron. PSII inhibitors act by inhibiting the transfer of electrons during photosynthesis. Inhibition blocks photosynthesis, the fixation of C02 and the production of ATP or NADPH. Plant death occurs due to the production of free radical species, which are able to initiate lipid peroxidation, and ultimately cell death. In case, (B) is a PSII inhibitor, (B) is preferably a triazines, more preferably selected from the group consisting of Terbuthylazine, Metribuzin and combinations thereof, more preferably Terbuthylazine.

In addition to the herbicide (A), and optionally herbicide (B), composition (I) and/or composition (II) may further comprise at least one safener (C).

Safeners are chemical compounds which prevent or reduce damage on useful plants without having a major impact on the herbicidal action of the herbicidal active components towards unwanted plants. Safeners can be applied before sowings (e.g. seed treatments), on shoots or seedlings as well as in the pre-emergence or post-emergence treatment of useful plants and their habitat.

Therefore, in one embodiment, composition (I) comprises at least one safener (C).

In another embodiment, composition (II) comprises at least one safener (C).

In another embodiment, composition (I) comprises at least one safener (C) and composition (II) comprises at least one safener (C1), wherein (C) and (C1) may be the same or may be different.

Exemplary safeners (C), and (C1), include benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthaleneacetic acid, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4), N-(2-Methoxybenzoyl)-4-[(methylaminocarbonyl)amino]benzenesulfonamide (CAS 129531-12-0), and agriculturally acceptable salts, esters or amides thereof.

In particular, the safener (C), and optionally (C1), are independently of each other selected from the group consisting of benoxacor, cloquintocet, cyprosulfamide, isoxadifen, mefenpyr, and agriculturally acceptable salts, esters or amides thereof.

Most preferably, the safener (C), and optionally (C1), are independently of each other selected from the group consisting of benoxacor, cloquintocet-mexyl, cyprosulfamide, isoxadifen-ethyl, and mefenpyr-diethyl.

The herbicides described hereinunder and above and the safeners are known herbicides and safeners, see, for example, The Pesticide Manual, British Crop Protection Council, 16th edition, 2012; The Compendium of Pesticide Common Names http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998.

If the safeners as described herein are capable of forming geometrical isomers, for example E/Z isomers, it is possible to use both, the pure isomers and mixtures thereof, in the compositions, uses and methods according to the invention. If the safeners as described herein have one or more centers of chirality and, as a consequence, are present as enantiomers or diastereomers, it is possible to use both, the pure enantiomers and diastereomers and their mixtures, in the compositions, uses and methods according to the invention.

### PPO-Inhibitor Tolerant Sunflower Plants

Herbicides (A) and (B) or the compositions thereof, as referred to herein shall be used in weed control in PPO-inhibitor tolerant sunflower plants. The plants may also have tolerance to other herbicides with a different mode of action, in particular to ALS inhibitors.

In an embodiment, the PPO-inhibitor tolerant sunflower crop is transgenic PPO-inhibitor tolerant sunflower crop.

In another embodiment, the PPO-inhibitor tolerant sunflower crop is non-transgenic PPO-inhibitor tolerant sunflower crop. Preferably, the non-transgenic crop plant is the PPO tolerant sunflower plants as defined in PCT/US2022/077037 which herewith is incorporated by reference with respect to the entire disclosure content (including the sequence listing), in particular with respect to the plant. The application was published as WO2023/049906A1. Seeds of the non-transgenic sunflower plant comprising a mutated protoporphyrinogen IX oxidase that are described in the Example section of the above PCT application (Helianthus annuus L., HA452 inbred line, designated “21LHHA000892”) have been deposited on Apr. 22, 2022 at the National Collections of Industrial, Food and Marine Bacteria (NCIMB), Aberdeen, United Kingdom under the provisions of the Budapest treaty on the International Recognition of the Deposit of Microorganisms for the Purposes of Patent Procedure. The deposited seeds were assigned the accession number NCIMB 43974. The deposition of seeds was made only for convenience of the person skilled in the art and does not constitute or imply any confession, admission, declaration or assertion that deposited seed are required to fully describe the invention, to fully enable the invention or for carrying out the invention or any part or aspect thereof. Also, the deposition of seeds does not constitute or imply any recommendation to limit the application of any method of the present invention to the application of the plants derived from said seeds.

Typically, the sunflower crop comprises a mutated protoporphyrinogen IX oxidase (PPO) gene encoding a mutated sunflower protoporphyrinogen IX oxidase, wherein the mutated sunflower protoporphyrinogen IX oxidase comprises a substitution of phenylalanine (F) to isoleucine (I) at a position corresponding to residue 383 relative to SEQ ID NO: 2 (F383I substitution).

Protoporphyrinogen IX oxidase (herein also referred to as “PPO” or “Protoporphyrinogen IX oxidase” catalyzes the seventh step in biosynthesis of protoporphyrin IX. In plants, protoporphyrin IX is the precursor to chlorophyll. Specifically, protoporphyrinogen IX oxidase (EC 1.3.3.4) catalyzes the dehydrogenation of protoporphyrinogen IX to form protoporphyrin IX. Preferably, the PPO polypeptide is a PPO2 polypeptide. For purposes herein, it is noted that PPO type II is used interchangeably with PPO2.

The term “mutated PPO gene” refers to a PPO nucleic acid molecule having a sequence that is mutated from a wild-type PPO gene, i.e. the wild-type PPO2 gene. The nucleic acid sequence of the sunflower wild-type PPO2 coding sequence is shown in SEQ ID NO: 3. The amino acid sequence of the wild-type PPO2 polypeptide is shown in SEQ ID NO: 4. As compared to the wild-type polypeptide, the mutated sunflower polypeptide shall comprise at least one mutation. Preferably, the mutated sunflower protoporphyrinogen IX oxidase comprises a substitution of phenylalanine (F) to isoleucine (I) at a position corresponding to residue 383 of SEQ ID NO: 4 or SEQ ID NO: 2 (F383I substitution). Thus, the mutated PPO oxidase shall comprise such a substitution at residue 383 relatively to SEQ ID NO: 4 (when aligned using blast). Position 383 in the sunflower PPO2 polypeptide corresponds to position 420 in the Amaranthus tuberculatus type II PPO.

In an embodiment of the present invention, the mutated protoporphyrinogen IX oxidase comprises an amino acid sequence as shown in SEQ ID NO: 2. However, the present invention is not limited to SEQ ID NO: 2. Rather, the present invention pertains also to variants of the mutated protoporphyrinogen IX oxidase comprising an amino acid sequence as shown in SEQ ID NO: 2, provided that the variant comprises the substitution of phenylalanine (F) to isoleucine (I) at a position corresponding to residue 383 of SEQ ID NO: 2 or 4.

In an embodiment, the mutated protoporphyrinogen IX oxidase (PPO) gene is the mutated protoporphyrinogen IX oxidase (PPO) gene of the sunflower plant obtained from growing a seed of mutant line 21LHHA000892, a sample of said seed having been deposited under NCIMB accession number 43974.

The expression “mutated amino acid” will be used below to designate the amino acid which is replaced by another amino acid, thereby designating the site of the mutation in the primary sequence of the protein.

The term “variant” with respect to a sequence (e.g., a polypeptide or nucleic acid sequence of the invention) is intended to mean substantially similar sequences. The variant polypeptide shall have protoporphyrinogen IX oxidase activity.

Enzyme variants may be defined by their sequence identity when compared to a parent enzyme. Sequence identity usually is provided as “% sequence identity” or “% identity”. To determine the percent-identity between two amino acid sequences in a first step a pairwise sequence alignment is generated between those two sequences, wherein the two sequences are aligned over their complete length (i.e., a pairwise global alignment). The alignment is generated with a program implementing the Needleman and Wunsch algorithm (J. Mol. Biol. (1979) 48, p. 443-453), preferably by using the program “NEEDLE” (The European Molecular Biology Open Software Suite (EMBOSS)) with the programs default parameters (gapopen=10.0, gapextend=0.5 and matrix=EBLOSUM62). The preferred alignment for the purpose of this invention is that alignment, from which the highest sequence identity can be determined.

The following example is meant to illustrate two nucleotide sequences, but the same calculations apply to protein sequences:
Seq A: AAGATACTG length: 9 bases
Seq B: GATCTGA length: 7 bases

Hence, the shorter sequence is sequence B.

Producing a pairwise global alignment which is showing both sequences over their complete lengths results in

Seq A: AAGATACTG-
||| |||
Seq B: --GAT-CTGA

The “|” symbol in the alignment indicates identical residues (which means bases for DNA or amino acids for proteins). The number of identical residues is 6.

The “-” symbol in the alignment indicates gaps. The number of gaps introduced by alignment within the Seq B is 1. The number of gaps introduced by alignment at borders of Seq B is 2, and at borders of Seq A is 1.

The alignment length showing the aligned sequences over their complete length is 10.

Producing a pairwise alignment which is showing the shorter sequence over its complete length according to the invention consequently results in:

Seq A: GATACTG-
||| |||
Seq B: GAT-CTGA

Producing a pairwise alignment which is showing sequence A over its complete length according to the invention consequently results in:

Seq A: AAGATACTG
||| |||
Seq B: --GAT-CTG

Producing a pairwise alignment which is showing sequence B over its complete length according to the invention consequently results in:

Seq A: GATACTG-
||| |||
Seq B: GAT-CTGA

The alignment length showing the shorter sequence over its complete length is 8 (one gap is present which is factored in the alignment length of the shorter sequence).

Accordingly, the alignment length showing Seq A over its complete length would be 9 (meaning Seq A is the sequence of the invention).

Accordingly, the alignment length showing Seq B over its complete length would be 8 (meaning Seq B is the sequence of the invention).

After aligning two sequences, in a second step, an identity value is determined from the alignment produced. For purposes of this description, percent identity is calculated by %-identity=(identical residues/length of the alignment region which is showing the two aligned sequences over their complete length)*100. Thus, sequence identity in relation to comparison of two amino acid sequences according to this embodiment is calculated by dividing the number of identical residues by the length of the alignment region which is showing the two aligned sequences over their complete length. This value is multiplied with 100 to give “%-identity”. According to the example provided above, %-identity is: (6/10)*100=60%.

Generally, amino acid sequence variants will have at least 70%, e.g., preferably at least 71%, 72%, 73%, 74%, 75%, 76%, 77%, 78%, to 79%, generally at least 80%, e.g., 81%-84%, at least 85%, e.g., 86%, 87%, 88%, 89%, 90%, 91%, 92%, 93%, 94%, 95%, 96%, 97%, at least 98%, at least 99% or at least 99.5% polypeptide “sequence identity” to the polypeptide of SEQ ID NO: 2, provided that the encoded polypeptide comprises the substitution of phenylalanine (F) to isoleucine (I) at a position corresponding to residue 383 of SEQ ID NO: 2. Thus, the variant polypeptide shall comprise an isoleucine residue at the position corresponding to position 383 of SEQ ID NO: 2 (or SEQ ID NO: 4).

Similarly, nucleotide sequence variants will have at least 30, 40, 50, 60, to 70%, e.g., preferably 71%, 72%, 73%, 74%, 75%, 76%, 77%, 78%, to 79%, generally at least 80%, e.g., 81%-84%, at least 85%, e.g., 86%, 87%, 88%, 89%, 90%, 91%, 92%, 93%, 94%, 95%, 96%, 97%, at least 98%, at least 99% or at least 99.5% nucleotide “sequence identity” to the nucleotide sequence encoding a polypeptide of SEQ ID NO: 2, provided that the encoded polypeptide comprises the substitution of phenylalanine (F) to isoleucine (I) at a position corresponding to residue 383 of SEQ ID NO: 2 or 4.

Similarly, nucleotide sequence variants will have at least 30, 40, 50, 60, to 70%, e.g., preferably 71%, 72%, 73%, 74%, 75%, 76%, 77%, 78%, to 79%, generally at least 80%, e.g., 81%-84%, at least 85%, e.g., 86%, 87%, 88%, 89%, 90%, 91%, 92%, 93%, 94%, 95%, 96%, 97%, at least 98%, at least 99% or at least 99.5% nucleotide “sequence identity” to the nucleic acid sequence of SEQ ID NO: 1, provided that the encoded polypeptide comprises the substitution of phenylalanine (F) to isoleucine (I) at a position corresponding to residue 383 of SEQ ID NO: 2 or 4.

In a preferred embodiment, the mutated protoporphyrinogen IX oxidase comprises: an amino acid sequence as shown in SEQ ID NO: 2, or a is a variant thereof being at least 98%, such as at least 99% or at least 99.5% identical to SEQ ID NO: 2, with the proviso that the variant comprises a substitution of phenylalanine (F) to isoleucine (I) at a position corresponding to residue 383.

Further, it is envisaged that the mutated protoporphyrinogen IX oxidase (PPO) gene comprises
a) a nucleic acid sequence as shown in SEQ ID NO: 1, or
b) a nucleic acid sequence being at least 98%, such as at least 99% or at least 99.5% identical to SEQ ID NO: 1.

Moreover, it is envisaged that the mutated PPO polypeptide comprises not more than three, such as not more than two, such as not more than one mutation in addition to the F383I substitution.

In an embodiment, the plant comprises a mutated PPO polypeptide encoded by a nucleic acid sequence as shown in SEQ ID NO: 1.

SEQ ID NO: 1 and 3 are coding sequences, i.e. sequences which are translated. The sunflower PPO2 gene comprises many introns. It is to be understood that the sequences of these introns are not comprised by SEQ ID NO: 1 and 3, respectively. Thus, the expression that “the mutated protoporphyrinogen IX oxidase (PPO) gene comprises a nucleic acid sequence” shall mean that plant expresses a transcript comprising said sequence.

By “herbicide-tolerant mutated PPO protein” or “herbicide-resistant mutated PPO protein”, it is intended that such a PPO protein displays higher PPO activity, relative to the PPO activity of the wild-type, i.e. the unmutated PPO protein, when in the presence of at least one herbicide that is known to interfere with PPO activity and at a concentration or level of the herbicide that is known to inhibit the PPO activity of the wild-type PPO protein. Furthermore, the PPO activity of such a herbicide-tolerant or herbicide-resistant mutated PPO protein may be referred to herein as “herbicide-tolerant” or “herbicide-resistant” PPO activity. The terms are used interchangeably herein. By a “herbicide-tolerant” or “herbicide-resistant” plant, it is intended that a plant that is tolerant or resistant to at least one herbicide at a level that would normally kill, or inhibit the growth of, a normal or wild-type plant.

The term “sunflower” as used herein, shall refer to any plant belonging to the genus Helianthus. In an embodiment, the term refers to a plant of the species Helianthus annuus. L.

In some embodiments, the mutated PPO gene is present in homozygous form in the plant (or part thereof).

As used herein, the term “homozygous” means a genetic condition existing when two identical alleles reside at a specific locus, but are positioned individually on corresponding pairs of homologous chromosomes in the cell. In contrast, the term “heterozygous” means a genetic condition existing when two different alleles reside at a specific locus, but are positioned individually on corresponding pairs of homologous chromosomes in the cell.

As used herein, the term “non-transgenic” refers to a plant or plant cell that does not have DNA derived from another organism inserted into its genome. Thus, the non-transgenic plant shall not have been produced by recombinant means. For example, the mutated PPO gene shall not have been introduced by transformation, such as Agrobacterium-mediated transformation. However, a non-transgenic plant or cell may have been produced by introducing a targeted mutation in the PPO2 gene, e.g. by gene editing.

If the plant used in the method of the present invention is non-transgenic, it will be understood that the mutated PPO2 gene shall be at the same position in the sunflower genome as the wildtype PPO2 gene. Thus, the mutated PPO2 gene may be operably linked to the native (i.e. wild-type) promoter of the protoporphyrinogen IX oxidase (PPO2) gene.

Typically, a non-transgenic plant has not been exclusively obtained by means of an essentially biological process.

The plant used in the method of the present invention shall be tolerant to PPO-inhibitors. In an embodiment of the present invention, the trait of tolerance to PPO-inhibitors is an endogenous non-transformed trait. Thus, the mutated PPO gene shall not have been introduced by transformation of a transgene. In an embodiment of the present invention, the trait of tolerance to PPO-inhibitors is an endogenous non-transfected trait. Thus, the PPO gene shall not have been mutated by gene editing.

In an embodiment, the plant has been produced by Ethyl methanesulfonate mutagenesis. Thus, the mutation in the PPO2 gene as referred to herein has been introduced by EMS (ethyl methanesulfonate) mutagenesis. Ethyl methanesulfonate (EMS) is a mutagenic compound that produces random mutations in genetic material by nucleotide substitution; particularly through G:C to A:T transitions induced by guanine alkylation.

In another embodiment of the present invention, the plant has been produced by radiation induced mutagenesis. Thus, the mutation in the PPO2 gene as referred to herein has been introduced by radiation induced mutagenesis.

Gene editing techniques may be currently feasible in sunflower, but where available such techniques could be used to produce the plants of the invention. In an embodiment of the present invention, the plant may be thus produced by genome editing. Thus, the mutation in the PPO2 gene as referred to herein may be introduced by genome editing. Genome editing, as used herein, refers to the targeted modification of genomic DNA using sequence-specific enzymes (such as endonuclease, nickases, base conversion enzymes) and/or donor nucleic acids (e.g. dsDNA, oligo's) to introduce desired changes in the DNA. Sequence-specific nucleases that can be programmed to recognize specific DNA sequences include meganucleases (MGNs), zinc-finger nucleases (ZFNs), TAL-effector nucleases (TALENs) and RNA-guided or DNA-guided nucleases such as Cas9, Cpf1, CasX, CasY, C2c1, C2c3, certain argonout systems (see e.g. Osakabe and Osakabe, Plant Cell Physiol. 2015 March; 56 (3): 389-400; Ma et al., Mol Plant. 2016 Jul. 6; 9 (7): 961-74; Bortesie et al., Plant Biotech J, 2016, 14; Murovec et al., Plant Biotechnol J. 2017 Apr. 1; Nakade et al., Bioengineered 8-3, 2017; Burstein et al., Nature 542, 37-241; Komor et al., Nature 533, 420-424, 2016; all incorporated herein by reference). Donor nucleic acids can be used as a template for repair of the DNA break induced by a sequence specific nuclease, but can also be used as such for gene targeting (without DNA break induction) to introduce a desired change into the genomic DNA.

By using the above technologies, plants comprising a wild-type sunflower PPO2 can be converted to plants comprising the mutated PPO2 gene as referred to herein, thereby increasing the tolerance to PPO-inhibitors.

As set forth herein elsewhere, the sunflower plant to be used in the method of the present invention shall be also tolerant not only to PPO herbicides A, but also to one or more herbicides (B), in particular to one or more herbicides selected from the group consisting of Auxin mimics, inhibitors of Protoporphyrinogen Oxidase (PPO), Acetolactate Synthase (ALS), Acetyl CoA Carboxylase (ACCase), Very Long-Chain Fatty Acid (VLCFA) synthesis, Microtubule Assembly and Photosynthesis at PSII. This may depend on the mode of action of the herbicide (B).

For example, if herbicide (B) is a further PPO inhibitor, such as Bifenox, Fomesafen, Pyraflufen, Sulfentrazone, Trifludimoxazin, the addition of a further herbicide tolerance trait to the plant is not required (i.e. other than the tolerance to PPO inhibitors).

The same typically applies, if herbicide (B) is an auxin mimic (such as Halauxifen), or an inhibitor of ACCase (such as Cycloxydim), VLCFA synthesis (such as DMTA-P), or microtuble assembly (such as Pendimethalin). The commercially used sunflower plants are, in principle, tolerant to these herbicides.

However, if herbicide (B) is an ALS-inhibitor, typically, it is required that the ALS-inhibitor tolerance trait has been added to the plant, thereby generating a sunflower plant that is tolerant to PPO inhibitors and to ALS inhibitors. As compared to wild-type sunflower plants, the plant treated in the method of the present invention thus comprises two additional herbicide tolerance traits.

Sunflower plants that are tolerant to ALS inhibitors are well-known in the art. Typically, the trait is conferred by one or more mutations in the acetohydroxyacid synthase (AHAS) gene (R gene). The thus mutated acetohydroxyacid synthase has lower binding to ALS inhibitors (as compared to the wild-type AHAS) which results in a reduced inhibiting efficiency of the ALS inhibitor. For example, in Clearfield crops, the tolerance trait is conferred by a single point mutation in the acetohydroxyacid synthase (AHAS) gene (R gene), with an alanine to valine substitution at position 205 (Arabidopsis alignment). This mutation is also referred to as the “A205(At) V” substitution. The “At” in brackets indicates that that the mutation is at a position corresponding to position 204 in the acetohydroxyacid synthase large subunit from Arabidopsis thaliana.

The Clearfield Plus production system is a based on a single gene with higher levels of tolerance to imidazolinones traits and provides sunflowers with greater crop tolerance regardless of environmental stresses, improved weed control, oil content and grain yield.

Therefore, the sunflower plant may also comprise a mutated gene encoding for a mutated AHASL (acetohydroxyacid synthase large subunit) which confers resistance to ALS inhibitors, such as to imidazolinone herbicides. Such mutated genes are described e.g. in WO 2008/124431 A1 (incorporated herein by reference).

In a preferred embodiment, the sunflower crop, preferably, additionally contains
a. a herbicide tolerance trait of (1) an AHASL (acetohydroxyacid synthase large subunit) having an A122(At) T substitution, or (2) an AHASL variant thereof that contains both the A122(At) T substitution and a second substitution that can be one or more of P197(At) Q, P197(At) S, P197(At) L T203(At) I, T203(At) X, A205(At) D, A205(At) V, W574(At) L, A653(At) N, A653(At) T, A653(At) F, or A653(At) V, wherein X may be selected as any natural amino acid;
b. two herbicide tolerance traits, the trait with the AHASL A122(At) T substitution and a second trait having an AHASL with an A205(At) V substitution, an AHASL with a P197(At) S substitution, an AHASL with a P197(At)L substitution or an AHASL with a W574(At) L substitution;
c. a herbicide tolerance trait having an AHASL with one A205(At) V substitution;
d. a herbicide tolerance trait having an AHASL with one P197(At) L substitution;
e. a herbicide tolerance trait having an AHASL with one P197(At) S substitution; or
f. a herbicide tolerance trait having an AHASL with one W574(At)L substitution.

The PPO herbicide tolerance trait and the ALS inhibitor tolerance trait can be combined in a sunflower plant by gene stacking. “Gene stacking”, also referred to as gene pyramiding, is the process of combining two or more genes of interest into a single plant. The combined traits resulting from this process are called stacked traits. When a stack is engineered or breed into a crop, the crop has better overall performance since a variety of genes for controlling different problems can in theory be stacked together. Moreover, gene stacking allows for better performance because if the resistance or tolerance conferred by a single gene breaks down, there is still a remaining gene that confers some benefit. Stacking can be achieved by transgenic approaches, by genome editing but, in particular, by using conventional breeding techniques. For example, a non-transgenic sunflower plant expressing a mutated PPO polypeptide can be crossed with a non-transgenic sunflower plant expressing a mutated AHASL polypeptide in order to obtain plants with both herbicide tolerance traits.

The present invention relates to a method for weed control. The method comprises the step of applying a composition as set forth herein above, i.e. the composition comprising herbicide (A) and herbicide (B) to the sunflower crop. The terms “crop” and “sunflower” are used interchangeably herein.

The term “weed control” is to be understood as meaning the killing of weeds and/or otherwise retarding or inhibiting the normal growth of the weeds. Weeds, in the broadest sense, are understood as meaning all those plants which grow in locations where they are undesired, e.g. (crop) plant cultivation sites. The weeds to be controlled include, for example, dicotyledonous and monocotyledonous weeds. Dicotyledonous weeds include, but are not limited to, weeds of the genera: Sinapis, Lepidium, Galium, Stellaria, Matricaria, Anthemis, Galinsoga, Chenopodium, Erigeron, Hibiscus, Urtica, Senecio, Amaranthus, Portulaca, Xanthium, Convolvulus, Ipomoea, Polygonum, Sesbania, Ambrosia, Mercuralis, Cirsium, Carduus, Sonchus, Solanum, Rorippa, Rotala, Lindernia, Lamium, Veronica, Abuthilon, Emex, Datura, Viola, Galeopsis, Papaver, Centaurea, Trifolium, Ranunculus, Helianthus, and Taraxacum. Monocotyledonous weeds include, but are not limited to, weeds of the genera: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemum, Sphenoclea, Dactyloctenium, Urochloa, Agrostis, Alopecurus, and Apera.

In a preferred embodiment, the weeds to be controlled are weeds which are common weeds in the cultivation of sunflower, such as one or more weeds selected from Convolvulus arvensis, Cirsium arvense, Xanthium spp., Abuthilon theophrasti, Polygonum spp., Sorghum halepense, Portulaca oleracea, Ambrosia ssp. (e.g. Ambrosia artemisiifolia, Ambrosia trifida), Sonchus oleraceus, Datura stramonium, Chenopodium album, Amaranthus spp. (e.g. Amaranthus retroflexus, Amaranthus palmeri), Echinochloa crus-galli. Setaria spp. (e.g. Setaria faberi), Sinapis spp, and Matricaria chamomilla.

Moreover, preferred weeds to be controlled are one or more weeds of the weeds in Table 2 in the Examples section.

In an embodiment, the weed is Amaranthus retroflexus.

In another embodiment, the weed is Amaranthus palmeri.

In yet another embodiment, the weed is Ambrosia trifida.

In yet another embodiment, the weed is Mercuralis annua.

In yet another embodiment, the weed is Echinochloa crus-galli.

In yet another embodiment, the weed is Urochloa texana.

In yet another embodiment, the weed is Eleusine indica.

In yet another embodiment, the weed is Setaria faberi.

In yet another embodiment, the weed is Digitaria sanguinalis.

The composition as set forth herein is applied at the cultivation site of the sunflower plant. The cultivation site may be any site at which the sunflower is grown or will be grown. In an embodiment, it is a greenhouse. In an alternative embodiment, it is a field. In an embodiment, the plant grown at the cultivation site, including the plant of the present invention and weed plants, are contacted with an effective amount of the herbicides, e.g. by spraying.

In the method of the present invention, the composition, i.e. the composition comprising herbicide (A) and/or herbicide (B) can be applied by any method known in the art including, but not limited to, soil treatment, and foliar treatment. Preferably, the herbicide or herbicides present in the composition are applied in an effective amount (as disclosed elsewhere). Prior to application, the herbicide can be converted into the customary formulations, for example solutions, emulsions, suspensions, dusts, powders, pastes and granules. The use form depends on the particular intended purpose; in each case, it should ensure a fine and even distribution of the composition. A wide variety of formulations can be employed for protecting plants from weeds, so as to enhance plant growth and reduce competition for nutrients. The herbicides as set forth herein can be used by itself for pre-emergence, post-emergence, pre-planting, and at-planting control of weeds in areas surrounding the crop plants described herein. Further, a herbicide formulation can be used that contains other additives. Additives found in herbicide formulation, detergents, adjuvants, spreading agents, sticking agents, stabilizing agents, or the like. The herbicide containing formulation can be a wet or dry preparation and can include, but is not limited to, flowable powders, emulsifiable concentrates, and liquid concentrates. The herbicide containing formulations can be applied in accordance with conventional methods, for example, by spraying, irrigation, dusting, or the like.

In an embodiment, the composition as set forth herein is applied by spraying.

According to the method of the present invention, the herbicide containing composition containing herbicide (A) and/or herbicide (B) is applied to the sunflower crop and/or the cultivation site of the sunflower crop pre-emergence or post-emergence of the sunflower crop, preferably post emergence of the sunflower crop, more preferably post-emergence of the sunflower crop and the weeds.

In an embodiment of the present invention, the composition as set forth herein is applied pre-emergence to the sunflower crop. For example, the composition can be applied about 1 to 14 days before emergence of the sunflower crop. In some embodiments, the composition is applied before sowing of the sunflower seed. In some embodiments, the composition is applied after sowing of the sunflower seed, but before emergence of the sunflower crop.

In another embodiment, the composition as set forth herein is applied post-emergence to the sunflower crop. For example, the composition is applied at BBCH stages 10 to 32 (of the sunflower crop), for example at BBCH stage 11, 12, 13, 14, 15, 16, 17 or 18 of the sunflower crop. The BBCH-scale is used to identify the phenological development stages of plants. The scale is e.g. described by Meier, U. (2001). “Growth stages of mono- and dicotyledonous plants”. BBCH Monograph. doi: 10.5073/bbch0515, incorporated by reference herein. Further, the scale is described in LANCASHIRE et al. (Annals of Applied Biology. Volume 119, Issue3. Available in: https://doi.org/10.1111/j.1744-7348.1991.tb04895.x).

The definitions and explanations given herein above preferably apply mutatis mutandis to the following.

The present invention further relates to the use of the composition as set forth in connection with the method of weed control in transgenic or non-transgenic PPO-inhibitor tolerant sunflower crop.

The present invention further relates to a method for producing a product from sunflower seeds, said method comprising
a) growing the sunflower plant as set forth in connection with the method of weed control at a plant cultivation site,
b) harvesting seeds from said plant, and
c) producing a product from the seeds harvested in step b.

Step a) of the above method may comprise the step of applying an effective amount of the composition comprising herbicide (A) and/or herbicide (B) (as defined in connection with the method of weed control) to said cultivation site as described elsewhere herein. In an embodiment, the composition is applied pre-emergence. In another embodiment, the composition is applied post-emergence.

Preferably, the plant grown at the cultivation site, including the plant of the present invention and weed plants, are contacted with an effective amount of the composition, e.g. by spraying.

In an embodiment of the method, the product is bird feed.

In another embodiment, the product is seed meal.

In another embodiment, the product is sunflower oil. Accordingly, the above methods may comprise the extraction of sunflower oil from the harvested or provided seeds.

All patents, patent applications, and publications or public disclosures referred to or cited herein are incorporated by reference in their entirety.

The invention will be further described with reference to the examples described herein; however, it is to be understood that the invention is not limited to such examples.

### Example 1: Study Set Up

The effect of the herbicidal compositions according to the invention on the growth of undesirable plants in a cultivation site of PPO inhibitor tolerant sunflowers compared to the herbicidally active compounds alone was found and demonstrated by the following field experiments:

Saflufenacil Combination with Pendimethalin

Trial Objective: Saflufenacil in tank mix with Pendimethalin efficacy on weeds and grasses in early post-emergence of the weeds

Saflufenacil Combination with Flumioxazin

Trial Objective: Efficacy of Saflufenacil in tank mix with Flumioxazin applied in pre-emergence of the weeds on bare ground.

Saflufenacil Combination with Sulfentrazone

Trial Objective: Efficacy of Saflufenacil in tank mix with Sulfentrazone applied in pre-emergence of the weeds on bare ground.

TABLE 1
Materials

| Herbicide | | |
|---|---|---|
| Tradename | Description | Source |
| SHARPEN ® | 342 g/l Saflufenacil SC | BASF Corporation |
| VALOR ® | 51% WG Flumioxazin | Valent Corporation |
| SPARTAN ® | 480 g/l Sulfentrazone | FMC Corporation |
| STOMP Aqua ® | 455 g/l Pendimethalin | BASF Corporation / |
| | | BASF SE |
| Water | Water | Local water source |

On field test sites, natural weed infestation was treated, pre-emergence of the weeds on bare soil or post-emergence of the weeds.

For the pre-emergence treatment, the active compounds, suspended or emulsified in water, were applied by means of finely distributing nozzles on bare ground.

For the post emergence treatment, the weedy plants were treated between the 2-4 true leaf stage (GS12-14) and the 6 true leaf stage (GS 16). The herbicidal compositions were suspended or emulsified in water as distribution medium and sprayed with commercial flat fan nozzles using between 100 and 200 l/ha water.

In the following experiments, the herbicidal activity for the individual herbicidal compositions (solo and mixture applications) was assessed up to 36 days after treatment (DAT). The assessments for the damage on undesired weeds caused by the chemical compositions was carried out using a scale from 0 to 100%, compared to the untreated control plants. Here, 0 means no damage and 100 means complete destruction of the plants.

TABLE 2
Weed List
The plants evaluated in the field experiments
belong to the following species:

| EPPO Code | Scientific name | English name |
|---|---|---|
| AMARE | Amaranthus retroflexus | pigweed |
| AMAPA | Amaranthus palmeri | Palmer amaranth |
| AMBTR | Ambrosia trifida | Giant ragweed |
| MERAN | Mercuralis annua | Annual mercury |
| ECHCG | Echinochloa crus-galli | Barnyard grass |
| PANTE | Urochloa texana | Texas panicum |
| ELEIN | Eleusine indica | goosgras |
| SETFA | Setaria faberi | Giant foxtail |
| DIGSA | Digitaria sanguinalis | Crabgrass |

Colby's equation was applied to determine whether the combination of herbicide (A) and herbicide (B) shows a synergistic effect (see S. R. Colby, “Calculating synergistic and antagonistic responses of herbicide combinations”, Weeds 1967, 15, pp. 20-22).

$$E = X + Y - ( {X}^{*} Y / 100 )$$

where X=effect in percent using herbicide (A) at an application rate a;
Y=effect in percent using herbicide (B) at an application rate b;
E=expected effect (in %) of herbicide (A)+herbicide (B) at application rates a+b.

The value E corresponds to the effect (plant damage or injury) which is to be expected if the activity of the individual compounds is additive. If the observed effect is higher than the value E calculated according to the Colby equation, a synergistic effect is present.

### Example 2: Results

Tables 3 to 5 show the results obtained in the studies described in Example 1. The tables show the expected effects (based on Colby) and the observed effects of the herbicidal compositions according to the invention of herbicides (A) and (B) on the growth of undesirable plants. Advantageously, synergistic effects were observed for tested compositions and for various herbicides.

TABLE 3
Postemergence application of Saflufenacil in combination with Pendimethalin

| | | | % Herbicidal activity | | | expected | |
|---|---|---|---|---|---|---|---|
| | g ai/ha total | | | | Saflufenacil + | activity | synergistic |
| Weed | Saflufenacil | Pendimethalin | Saflufenacil | Pendimethalin | Pendimethalin | (Colby)* | activity |
| AMARE | 12.5 | 840 | 35 | 37 | 75 | 59 | +16 |
| ECHCG | 12.5 | 1365 | 5 | 36 | 45 | 39 | +6 |
| AMARE | 12.5 | 1064 | 60 | 80 | 95 | 92 | +3 |
| MERAN | 12.5 | 1365 | 0 | 42 | 80 | 42 | +38 |
| ECHCG | 12.5 | 1064 | 0 | 80 | 89 | 80 | +9 |
| ECHCG | 50 | 1064 | 0 | 80 | 94 | 80 | +14 |

TABLE 4
Preemergence application of Saflufenacil in combination with Flumioxazin

| | | | | % Herbicidal activity | | | expected | |
|---|---|---|---|---|---|---|---|---|
| | App. | g ai/ha total | | | | Saflufenacil + | activity | synergistic |
| Weed | Timing | Saflufenacil | Flumioxazin | Saflufenacil | Flumioxazin | Flumioxazin | (Colby)* | activit |
| AMAPA | Preem | 25 | 71.4 | 27 | 85 | 92 | 89 | +3 |
| PANTE | Preem | 50 | 71.4 | 13 | 35 | 50 | 43 | +7 |
| DIGSA | Preem | 25 | 71.4 | 7 | 88 | 93 | 89 | +4 |
| AMBTR | Preem | 50 | 71.4 | 67 | 65 | 91 | 88 | +3 |
| ELEIN | Preem | 25 | 71.4 | 3 | 80 | 87 | 81 | +6 |
| SETFA | Preem | 50 | 71.4 | 37 | 72 | 92 | 82 | +10 |

TABLE 5
Preemergence application of Saflufenacil in combination with Sulfentrazone

| | | | % Herbicidal activity | | | expected | |
|---|---|---|---|---|---|---|---|
| | g ai/ha total | | | | Saflufenacil + | activity | synergistic |
| Weed | Saflufenacil | Sulfentrazone | Saflufenacil | Sulfentrazone | Sulfentrazone | (Colby)* | activity |
| ELEIN | 25 | 210 | 8 | 80 | 89 | 82 | +7 |
| PANTE | 25 | 210 | 20 | 45 | 59 | 56 | +3 |

### Example 3: Study Set Up

The effect of the herbicidal compositions according to the invention on the growth of undesirable plants and sunflower crop compared to the herbicidally active compounds alone was demonstrated by the following greenhouse experiments:

For the post emergence treatment, the plants were first grown to the 2 to 4 leaf stage (GS 12/14). The plants were cultivated due to their individual requirements at 10-25° C. and 20-35° C. The plants were irrigated as required.

Here, the herbicidal compositions were suspended or emulsified in water as distribution medium and sprayed using finely distributing nozzles. 1% methylated seed oil (MSO) has been added as adjuvant to each of the solo and mixture treatments.

In the greenhouse experiments, the herbicidal activity for the individual herbicidal compositions (solo and mixture applications) was assessed 20/21 days after treatment (DAT).

The evaluation for the damage on undesired weeds caused by the chemical compositions was carried out using a scale from 0 to 100%, compared to the untreated control plants. Here, 0 means no damage and 100 means complete destruction of the plants.

TABLE 6
Materials:

| Herbicide | | |
|---|---|---|
| Tradename | Description | Source |
| KIXOR ® | 70% WG Saflufenacil | BASF Corporation |
| PLEDGE ®500WG | 50% WG Flumioxazin | Sumitomo Chemical |
| BEYOND ® | 120 g/l SL Imazamox | BASF Corporation |
| EXPRESS ® | 50% WG Tribenuron-methyl | FMC Corporation |
| HELIANTHEX ™ | 68.6 g/l SC Halauxifen | Corteva |
| QUICKDOWN ® | 26 g/l EC Pyraflufen-ethyl | Belchim Crop |
| | | Protection NV/SA |
| FLEX ® | 250 g/l SL Fomesafen | Syngenta Crop |
| | | Protection |
| FOX ® | 480 g/l SC Bifenox | ADAMA |
| SELECT ® | 240 g/l EC Clethodim | UPL Europe Ltd. |
| Water | Water | Local water source |

TABLE 7
Weed List
The plants used in the greenhouse experiments
belonged to the following species:

| EPPO | Code Scientific name |
|---|---|
| ABUTH | Abutilon theophrasti |
| CHEAL | Chenopodium album |
| ECHCG | Echinochloa crus-galli |
| SETVI | Setaria viridis |
| SORHA | Sorghum halepense |
| AMBEL | Ambrosia artemisiifolia |
| MERAN | Mercuralis annua |
| HIBTR | Hibiscus trionum |
| PAPRH | Papaver rhoeas |
| CONAR | Convolvulus arvensis |
| MATCH | Matricaria chamomilla |
| SONAR | Sonchus arvensis |
| POLAV | Polygonum aviculare |
| ERICA | Erigeron canadensis |
| POROL | Portulaca oleracea |
| SOLNI | Solanum nigrum |
| HELAN | Helianthus annuus |

Colby's equation, as described in Example 1, was applied to determine whether the combination of herbicide (A) and herbicide (B) shows a synergistic effect.

TABLE 8
Synergistic effect of Flumioxazin in combination with Imazamox

| | | | | % Herbicidal activity | | | expected |
|---|---|---|---|---|---|---|---|
| | | g ai/ha total | | | | Saflufenacil + | activity |
| Weed | App. Timing | Flumioxazin | Imazamox | Flumioxazin | Imazamox | Flumioxazin | (Colby)* |
| AMBEL | BBCH 12-14 | 4 | 10 | 95 | 85 | 100 | 99 |
| ABUTH | BBCH 12-14 | 1 | 10 | 90 | 84 | 100 | 98 |
| HIBTR | BBCH 12-14 | 0.5 | 10 | 75 | 65 | 95 | 91 |
| MERAN | BBCH 12-14 | 0.5 | 10 | 70 | 30 | 98 | 79 |

TABLE 9
Synergistic effect of Flumioxazin in combination with Tribenuron-methyl

| | | | | % Herbicidal activity | | | |
|---|---|---|---|---|---|---|---|
| | | g ai/ha total | | | | Flumioxazin + | expected |
| | | | Tribenuron- | | Tribenuron- | Tribenuron- | activity |
| Weed | App. Timing | Flumioxazin | methyl | Flumioxazin | methyl | methyl | (Colby)* |
| SETVI | BBCH 12-14 | 2 | 6 | 70 | 25 | 85 | 78 |
| PAPRH | BBCH 12-14 | 2 | 6 | 85 | 95 | 100 | 99 |

TABLE 10
Synergistic effect of Flumioxazin in combination with Halauxifen

| | | | | % Herbicidal activity | | | expected |
|---|---|---|---|---|---|---|---|
| | | g ai/ha total | | | | Flumioxazin + | activity |
| Weed | App. Timing | Flumioxazin | Halauxifen | Flumioxazin | Halauxifen | Halauxifen | (Colby)* |
| SETVI | BBCH 12-14 | 0.5 | 1 | 30 | 70 | 85 | 79 |
| CONAR | BBCH 12-14 | 0.5 | 1 | 65 | 60 | 100 | 86 |
| PAPRH | BBCH 12-14 | 0.5 | 1 | 85 | 95 | 100 | 99 |
| MATCH | BBCH 12-14 | 2 | 1 | 65 | 5 | 80 | 67 |
| SONAR | BBCH 12-14 | 2 | 1 | 50 | 65 | 90 | 83 |

TABLE 11
Synergistic effect of Flumioxazin in combination with Pyraflufen-ethyl

| | | | | % Herbicidal activity | | | |
|---|---|---|---|---|---|---|---|
| | | g ai/ha total | | | | Flumioxazin + | expected |
| | | | Pyraflufen- | | Pyraflufen- | Pyraflufen- | activity |
| Weed | App. Timing | Flumioxazin | ethyl | Flumioxazin | ethyl | ethyl | (Colby)* |
| SONAR | BBCH 12-14 | 0.5 | 1.5 | 50 | 98 | 100 | 99 |
| CONAR | BBCH12-14 | 0.5 | 1.5 | 65 | 70 | 100 | 90 |
| POLAV | BBCH 12-14 | 0.5 | 1.5 | 45 | 90 | 100 | 95 |
| ERICA | BBCH 12-14 | 1 | 1.5 | 60 | 80 | 100 | 92 |

TABLE 12
Synergistic effect of Flumioxazin in combination with Fomesafen

| | | | | % Herbicidal activity | | | expected |
|---|---|---|---|---|---|---|---|
| | | g ai/ha total | | | | Flumioxazin + | activity |
| Weed | App. Timing | Flumioxazin | Fomesafen | Flumioxazin | Fomesafen | Fomesafen | (Colby)* |
| SOLNI | BBCH 12-14 | 1 | 123 | 90 | 90 | 100 | 99 |
| ECHCG | BBCH 12-14 | 2 | 123 | 55 | 85 | 95 | 93 |
| CHEAL | BBCH 12-14 | 2 | 123 | 70 | 80 | 95 | 94 |
| MATCH | BBCH 12-14 | 1 | 123 | 60 | 85 | 100 | 94 |
| CONAR | BBCH 12-14 | 0.5 | 123 | 65 | 70 | 100 | 90 |

TABLE 13
Synergistic effect of Flumioxazin in combination with Bifenox

| | | | | % Herbicidal activity | | | expected |
|---|---|---|---|---|---|---|---|
| | | g ai/ha total | | | | Flumioxazin + | activity |
| Weed | App. Timing | Flumioxazin | Bifenox | Flumioxazin | Bifenox | Bifenox | (Colby)* |
| POROL | BBCH 12-14 | 4 | 168 | 98 | 10 | 100 | 98 |
| ABUTH | BBCH 12-14 | 2 | 168 | 98 | 55 | 100 | 99 |
| SONAR | BBCH 12-14 | 0.5 | 168 | 50 | 30 | 75 | 65 |
| CHEAL | BBCH 12-14 | 1 | 168 | 70 | 20 | 90 | 76 |
| PAPRH | BBCH 12-14 | 0.5 | 168 | 85 | 10 | 100 | 87 |
| POLAV | BBCH 12-14 | 4 | 168 | 95 | 20 | 98 | 96 |

TABLE 14
Synergistic effect of Saflufenacil in combination with Flumioxazin

| | | | | % Herbicidal activity | | | expected |
|---|---|---|---|---|---|---|---|
| | | g ai/ha total | | | | Saflufenacil + | activity |
| Weed | App. Timing | Saflufenacil | Flumioxazin | Saflufenacil | Flumioxazin | Flumioxazin | (Colby)* |
| SORHA | BBCH 12-14 | 4 | 2 | 60 | 50 | 98 | 80 |
| SETVI | BBCH 12-14 | 1 | 2 | 70 | 65 | 90 | 90 |
| HIBTR | BBCH 12-14 | 0.5 | 2 | 80 | 90 | 100 | 98 |
| ERICA | BBCH 12-14 | 1 | 2 | 90 | 75 | 100 | 98 |
| POLAV | BBCH 12-14 | 1 | 2 | 3 | 80 | 87 | 81 |
| MATCH | BBCH 12-14 | 1 | 2 | 45 | 75 | 90 | 86 |

TABLE 15
Synergistic effect of Saflufenacil in combination with Imazamox

| | | | | % Herbicidal activity | | | expected |
|---|---|---|---|---|---|---|---|
| | | g ai/ha total | | | | Saflufenacil + | activity |
| Weed | App. Timing | Saflufenacil | Imazamox | Saflufenacil | Imazamox | Imazamox | (Colby)* |
| SETVI | BBCH 12-14 | 0.5 | 10 | 25 | 75 | 85 | 81 |
| AMBEL | BBCH 12-14 | 1 | 10 | 80 | 75 | 100 | 95 |
| MATCH | BBCH 12-14 | 1 | 10 | 45 | 35 | 80 | 64 |

TABLE 15
Synergistic effect of Saflufenacil in combination with Tribenuron-methyl

| | | | | % Herbicidal activity | | | |
|---|---|---|---|---|---|---|---|
| | | g ai/ha total | | | | Saflufenacil + | expected |
| | | | Tribenuron- | | Tribenuron- | Tribenuron- | activity |
| Weed | App. Timing | Saflufenacil | methyl | Saflufenacil | methyl | methyl | (Colby)* |
| AMBEL | BBCH 12-14 | 1 | 6 | 80 | 90 | 100 | 98 |

TABLE 16
Synergistic effect of Saflufenacil in combination with Halauxifen

| | | | | % Herbicidal activity | | | expected |
|---|---|---|---|---|---|---|---|
| | | g ai/ha total | | | | Saflufenacil + | activity |
| Weed | App. Timing | Saflufenacil | Halauxifen | Saflufenacil | Halauxifen | Halauxifen | (Colby)* |
| CONAR | BBCH 12-14 | 0.5 | 1 | 30 | 70 | 85 | 79 |
| MATCH | BBCH 12-14 | 2 | 1 | 98 | 65 | 100 | 99 |

TABLE 17
Synergistic effect of Saflufenacil in combination with Fomesafen

| | | | | % Herbicidal activity | | | expected |
|---|---|---|---|---|---|---|---|
| | | g ai/ha total | | | | Saflufenacil + | activity |
| Weed | App. Timing | Saflufenacil | Fomesafen | Saflufenacil | Fomesafen | Fomesafen | (Colby)* |
| ECHCG | BBCH 12-14 | 4 | 123 | 85 | 95 | 100 | 99 |
| ABUTH | BBCH 12-14 | 2 | 1 | 70 | 94 | 100 | 98 |

TABLE 18
Synergistic effect of Saflufenacil in combination with Bifenox

| | | | | % Herbicidal activity | | | expected |
|---|---|---|---|---|---|---|---|
| | | g ai/ha total | | | | Saflufenacil + | activity |
| Weed | App. Timing | Saflufenacil | Bifenox | Saflufenacil | Bifenox | Bifenox | (Colby)* |
| SORHA | BBCH 12-14 | 4 | 168 | 60 | 10 | 75 | 64 |
| AMBEL | BBCH 12-14 | 1 | 168 | 80 | 60 | 100 | 92 |
| ABUTH | BBCH 12-14 | 1 | 168 | 90 | 80 | 100 | 98 |
| MERAN | BBCH 12-14 | 0.5 | 168 | 60 | 55 | 95 | 82 |
| PAPRH | BBCH 12-14 | 0.5 | 168 | 95 | 5 | 98 | 95 |
| CONAR | BBCH 12-14 | 1 | 168 | 80 | 75 | 100 | 95 |

TABLE 19
Synergistic effect of Saflufenacil in combination with Clethodim

| | | | | % Herbicidal activity | | | expected |
|---|---|---|---|---|---|---|---|
| | | g ai/ha total | | | | Saflufenacil + | activity |
| Weed | App. Timing | Saflufenacil | Clethodim | Saflufenacil | Clethodim | Clethodim | (Colby)* |
| AMBEL | BBCH 12-14 | 1 | 30 | 80 | 10 | 90 | 82 |
| HIBTR | BBCH 12-14 | 0.5 | 30 | 80 | 10 | 85 | 82 |
| CHEAL | BBCH 12-14 | 4 | 30 | 95 | 0 | 100 | 95 |
| MATCH | BBCH 12-14 | 0.5 | 30 | 45 | 0 | 55 | 45 |
| SONAR | BBCH 12-14 | 0.5 | 30 | 98 | 5 | 100 | 98 |
| CONAR | BBCH 12-14 | 0.5 | 30 | 30 | 0 | 60 | 30 |
| POLAV | BBCH 12-14 | 0.5 | 30 | 75 | 0 | 80 | 75 |

TABLE 20
Crop safety of PPO inhibitor tolerant sunflower-Flumioxazin in combination with Halauxifen

| | | g ai/ha total | | Observed crop damage 21 days after treatment | | |
|---|---|---|---|---|---|---|
| Crop | App. Timing | Flumioxazin | Halauxifen | Flumioxazin | Halauxifen | Flumioxazin + Halauxifen |
| HELAN | BBCH 12-14 | 0.5 | 1 | 65 | 5 | 80 |
| Pacino | | | | | | |
| HELAN w | BBCH 12-14 | 0.5 | 1 | 15 | 15 | 25 |
| F(383)I | | | | | | |

TABLE 21
Crop safety of PPO inhibitor tolerant sunflower-Flumioxazin in combination with Bifenox

| | | g ai/ha total | | Observed crop damage 21 days after treatment | | |
|---|---|---|---|---|---|---|
| Crop | App. Timing | Flumioxazin | Bifenox | Flumioxazin | Bifenox | Flumioxazin + Bifenox |
| HELAN | BBCH 12-14 | 0.5 | 168 | 65 | 15 | 65 |
| Pacino | | | | | | |
| HELAN w | BBCH 12-14 | 0.5 | 168 | 15 | 5 | 45 |
| F(383)I | | | | | | |

1. A method for weed control in Protoporphyrinogen Oxidase (PPO)-inhibitor tolerant sunflower crop, comprising applying to said sunflower crop and/or the cultivation site of said sunflower crop a composition (I) comprising a PPO-inhibitor (A) or an agriculturally acceptable salt or derivative thereof, selected from the group consisting of saflufenacil, flumioxazin and combinations thereof.

2. The method of claim 1, wherein the composition (I) is applied pre-emergence of the PPO inhibitor tolerant sunflower crop.

3. The method of claim 1, wherein the composition (I) is applied post-emergence of the PPO inhibitor tolerant sunflower crop.

4. The method of claim 1, wherein additionally a herbicide (B) or an agriculturally acceptable salt or derivative thereof is applied to the sunflower crop and/or the cultivation site of said sunflower crop, wherein (B) is selected from the group consisting of Auxin mimics, inhibitors of Protoporphyrinogen Oxidase (PPO), Acetolactate Synthase (ALS), Acetyl COA Carboxylase (ACCase), Very Long-Chain Fatty Acid (VLCFA) Synthesis, Microtubule Assembly and Photosynthesis at PSII, and combinations thereof.

5. The method of claim 4, wherein the PPO inhibitor (A) and the herbicide (B) are applied in synergistically effective amounts.

6. The method of claim 4, wherein (B) is a further PPO-inhibitor selected from the group consisting of Bifenox, Fomesafen, Pyraflufen-ethyl, Sulfentrazone, Trifludimoxazin and combinations thereof.

7. The method of claim 4, wherein (B) is an ALS inhibitor selected from the group consisting of imidazolinones, sulfonylureas and combinations thereof.

8. The method of claim 7, wherein the ALS-inhibitor is selected from the group consisting of Imazamox, Imazapyr, Imazethapyr, and Tribenuron methyl.

9. The method of claim 4, wherein (B) is an ACCase inhibitor selected from the group consisting of Cycloxydim, Clethodim, Tepraloxydim, Sethoxydim, Propaquizafop-ethyl, Clodinafop-ethyl, Fenoxyprop, and Quizalofop-ethyl.

10. The method of claim 4, wherein (B) is an inhibitor of VLCFA synthesis, selected from the group consisting of Dimethenamid-P, S-Metolachlor, Pethoxamid, Acetochlor, and Metazachlor.

11. The method of claim 4, wherein (B) is an inhibitor of Microtubule assembly, selected from the group consisting of Pendimethalin and Trifluralin.

12. The method of claim 4, wherein (B) is an Auxin mimic selected from the group consisting of Halauxifen and Halauxifen-ethyl.

13. The method of claim 4, wherein (B) is a PSII inhibitor, selected from the group consisting of Terbuthylazine and Metribuzin.

14. The method according to claim 1, wherein the PPO-inhibitor tolerant sunflower crop is a non-transgenic PPO-inhibitor tolerant sunflower crop.

15. The method according to claim 1, wherein the PPO-inhibitor tolerant sunflower crop is a transgenic PPO-inhibitor tolerant sunflower crop.

16. The method of claim 14, wherein the sunflower crop comprises a mutated protoporphyrinogen IX oxidase (PPO) gene encoding a mutated sunflower protoporphyrinogen IX oxidase, wherein the mutated sunflower Protoporphyrinogen IX Oxidase comprises a substitution of phenylalanine (F) to isoleucine (I) at a position corresponding to residue 383 relative to SEQ ID NO: 2 (F383I substitution).

17. A composition (I) comprising (Ia) a PPO-inhibitor (A) selected from the group consisting of saflufenacil, flumioxazin and combinations thereof or an agriculturally acceptable salt or derivative thereof or (Ib) a PPO-inhibitor (A) selected from the group consisting of saflufenacil, flumioxazin and combinations thereof or an agriculturally acceptable salt or derivative thereof and a herbicide (B) or an agriculturally acceptable salt or derivative thereof selected from the group consisting of Auxin mimics, inhibitors of Protoporphyrinogen Oxidase (PPO), Acetolactate Synthase (ALS), Acetyl CoA Carboxylase (ACCase), Very Long-Chain Fatty Acid (VLCFA) Synthesis, Microtubule Assembly and Photosynthesis at PSII, and combinations thereof.

18. The method of claim 15, wherein the sunflower crop comprises a mutated protoporphyrinogen IX oxidase (PPO) gene encoding a mutated sunflower protoporphyrinogen IX oxidase, wherein the mutated sunflower Protoporphyrinogen IX Oxidase comprises a substitution of phenylalanine (F) to isoleucine (I) at a position corresponding to residue 383 relative to SEQ ID NO: 2 (F383I substitution).


SEQUENCE LISTING (4 sequences)

SEQ ID NO: 1 - DNA, 1476 bp, synthetic construct
  source 1..1476: mol_type = other DNA; note = Mutated sunflower PPO2 coding sequence (F383I mutation in encoded protein)
atggcttcaccaactacacctgacaaccaaaaacctgctaagcgagttgccgttgttggtgccggtgtcagtggttgtgctgctgcttataagttaaagttacatggattaaatgtcactgtctttgaagctgatgggagagtaggcgggaaactacggagcgtttcgcaagatggtttaatatgggatgagggtgccaatactatgactgagagtgaggcagaggtcagcagtttgattgatgatcttgggcttcgagataaacaacagtttccgatttcacagcacaagcggtacattgtaagaaatggaaaacctgtactgataccttctaacccaattgcactgatcagaagcagttttctttccactcagtcgaaggttcaaattcttttggagccgtttttatggaagaagaataagtcatctgacgcaccagagagtgttggagaattctttcaacgtcattttgggaaggaggttgttgagtatctcattgatccagttgttgcgggaacaagcggcggagatcccgaatcactttctatgcgtcatgcatttcctgagttatgggatttagaaagaaggtttggttcaatcgtttccggggcatttcagtctatggtatcttccagaaatgggaaaaggaaaccttctggaaacagcaaacgtaggcgtggttctttttcgtttttcggtggaatgcagacactcactgatgcactatgcaaagagatcggaccccatgaacttaatcttcaatcaaaggtgcttgaaatgtcctacaactgcgatggtaacgcggttggtaattggtcaatatgttgtgctccagatcaaaacaaacaatttcagcaatctttcgatgctgtgatcatgactgccccacttggcaatgtaaaagaaatgaagattacaaagatcggaagtccgtttccgcttaatttcataccagaggtgagttatatgccaatatcagtaataatctcgactttcaagaaagaaaacgtgaagcagcccctcgagggttttggagttcttgttccagccaaggagcagaaaaatggtttgaggacactaggcactctcttctcctcgatgatgtttccagatcgcgcctcggaagacgtgtacctttacaccaccattgttgggggtagtcgaaacaaagaactggccaaagcttcgagggacgagttgaagcatatagtaacttctgacctcagactgttgcttggaacagaaggggagccaaaatttctaactcactattattggagcaaagcatttccattgtatgggcgcggctatggttcagtcattgaagcaattgagaaaatggaaagggagctacccggatacttttatgcaggtaaccacaaaggagggctctctgtcgggaaagcaatatcctcgggatgcaaagcagccgaatctgtgatcgcatacttggattcttattcggacgagaagtag

SEQ ID NO: 2 - protein, 491 aa, synthetic construct
  source 1..491: note = Mutated sunflower PPO2 protein (F383I substitution)
MASPTTPDNQKPAKRVAVVGAGVSGCAAAYKLKLHGLNVTVFEADGRVGGKLRSVSQDGLIWDEGANTMTESEAEVSSLIDDLGLRDKQQFPISQHKRYIVRNGKPVLIPSNPIALIRSSFLSTQSKVQILLEPFLWKKNKSSDAPESVGEFFQRHFGKEVVEYLIDPVVAGTSGGDPESLSMRHAFPELWDLERRFGSIVSGAFQSMVSSRNGKRKPSGNSKRRRGSFSFFGGMQTLTDALCKEIGPHELNLQSKVLEMSYNCDGNAVGNWSICCAPDQNKQFQQSFDAVIMTAPLGNVKEMKITKIGSPFPLNFIPEVSYMPISVIISTFKKENVKQPLEGFGVLVPAKEQKNGLRTLGTLFSSMMFPDRASEDVYLYTTIVGGSRNKELAKASRDELKHIVTSDLRLLLGTEGEPKFLTHYYWSKAFPLYGRGYGSVIEAIEKMERELPGYFYAGNHKGGLSVGKAISSGCKAAESVIAYLDSYSDEK

SEQ ID NO: 3 - DNA, 1476 bp, Helianthus annuus
  source 1..1476: mol_type = other DNA; note = Wild-type sunflower PPO2 (coding sequence)
atggcttcaccaactacacctgacaaccaaaaacctgctaagcgagttgccgttgttggtgccggtgtcagtggttgtgctgctgcttataagttaaagttacatggattaaatgtcactgtctttgaagctgatgggagagtaggcgggaaactacggagcgtttcgcaagatggtttaatatgggatgagggtgccaatactatgactgagagtgaggcagaggtcagcagtttgattgatgatcttgggcttcgagataaacaacagtttccgatttcacagcacaagcggtacattgtaagaaatggaaaacctgtactgataccttctaacccaattgcactgatcagaagcagttttctttccactcagtcgaaggttcaaattcttttggagccgtttttatggaagaagaataagtcatctgacgcaccagagagtgttggagaattctttcaacgtcattttgggaaggaggttgttgagtatctcattgatccagttgttgcgggaacaagcggcggagatcccgaatcactttctatgcgtcatgcatttcctgagttatgggatttagaaagaaggtttggttcaatcgtttccggggcatttcagtctatggtatcttccagaaatgggaaaaggaaaccttctggaaacagcaaacgtaggcgtggttctttttcgtttttcggtggaatgcagacactcactgatgcactatgcaaagagatcggaccccatgaacttaatcttcaatcaaaggtgcttgaaatgtcctacaactgcgatggtaacgcggttggtaattggtcaatatgttgtgctccagatcaaaacaaacaatttcagcaatctttcgatgctgtgatcatgactgccccacttggcaatgtaaaagaaatgaagattacaaagatcggaagtccgtttccgcttaatttcataccagaggtgagttatatgccaatatcagtaataatctcgactttcaagaaagaaaacgtgaagcagcccctcgagggttttggagttcttgttccagccaaggagcagaaaaatggtttgaggacactaggcactctcttctcctcgatgatgtttccagatcgcgcctcggaagacgtgtacctttacaccacctttgttgggggtagtcgaaacaaagaactggccaaagcttcgagggacgagttgaagcatatagtaacttctgacctcagactgttgcttggaacagaaggggagccaaaatttctaactcactattattggagcaaagcatttccattgtatgggcgcggctatggttcagtcattgaagcaattgagaaaatggaaagggagctacccggatacttttatgcaggtaaccacaaaggagggctctctgtcgggaaagcaatatcctcgggatgcaaagcagccgaatctgtgatcgcatacttggattcttattcggacgagaagtag

SEQ ID NO: 4 - protein, 491 aa, Helianthus annuus
  source 1..491: note = Wild-type sunflower PPO2 protein
MASPTTPDNQKPAKRVAVVGAGVSGCAAAYKLKLHGLNVTVFEADGRVGGKLRSVSQDGLIWDEGANTMTESEAEVSSLIDDLGLRDKQQFPISQHKRYIVRNGKPVLIPSNPIALIRSSFLSTQSKVQILLEPFLWKKNKSSDAPESVGEFFQRHFGKEVVEYLIDPVVAGTSGGDPESLSMRHAFPELWDLERRFGSIVSGAFQSMVSSRNGKRKPSGNSKRRRGSFSFFGGMQTLTDALCKEIGPHELNLQSKVLEMSYNCDGNAVGNWSICCAPDQNKQFQQSFDAVIMTAPLGNVKEMKITKIGSPFPLNFIPEVSYMPISVIISTFKKENVKQPLEGFGVLVPAKEQKNGLRTLGTLFSSMMFPDRASEDVYLYTTFVGGSRNKELAKASRDELKHIVTSDLRLLLGTEGEPKFLTHYYWSKAFPLYGRGYGSVIEAIEKMERELPGYFYAGNHKGGLSVGKAISSGCKAAESVIAYLDSYSDEK